(19) United States
(12) Patent Application Publication
(10) Pub. No.: US 2008/0242584 A1
(43) Pub. Date: Oct. 2, 2008

(54) Fabric care composition

(76) Inventors: Errol Hoffman Wahl, Cincinnati, OH (US); Gayle Marie Frankenbach, Cincinnati, OH (US); Jodi Lee Brown, Cincinnati, OH (US); Tania Edmee Berges Cabrera, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/080,358

(22) Filed: Apr. 2, 2008

Related U.S. Application Data
(60) Provisional application No. 60/921,371, filed on Apr. 2, 2007.

(51) Int. Cl. C11D 3/37

(52) U.S. Cl. 510/517

(57) ABSTRACT

A fabric enhancer composition comprising: (a) a cationic polymer; (b) less than about 20% silicone; and (c) a deposition aid; wherein the composition is essentially free of a coacervate.

### CROSS REFERENCE TO RELATED APPLICATION

This application claims the benefit of U.S. Provisional Application No. 60/921,371, filed Apr. 2, 2007.

### BACKGROUND OF THE INVENTION

Conventional fabric softening compositions are added in the rinse cycle of the laundering process to soften fabrics or as dryer added softener sheets to a machine dryer. While various softening compositions added in the rinse cycle are known, these compositions lack in delivering fully enough softening and/or other consumer desired benefits to the laundry.

While compositions exist that utilize coacervate phases such as softening through the wash (STW) compositions, it is believed that such phases may reduce the overall softness feel when attempting to use with conventional quaternary ammonium softening compounds, especially in rinse-added compositions. This reduction results in sub-optimal results.

There is a need in the art to deliver an improved softening benefit to the laundry. Moreover, there is a need to deliver this improved need during the laundering process. This invention meets those needs.

### SUMMARY OF THE INVENTION

In one aspect of the invention, there is a fabric enhancer composition comprising: a. a cationic polymer; b. less than about 20% silicone; c. a deposition aid; wherein the composition is essentially free of a coacervate.

### DETAILED DESCRIPTION OF THE INVENTION

As used herein, “deposition aids” are materials that enhance or enable the deposition of main fabric care materials on fabric article to provide the desired benefits. The “deposition aids” can be chemicals or compounds that are cationically modified by quaternized amines thus carry “permanent” cationic charge(s), or can potentially carry cationic charge(s) or polarity in the use medium through protonation of nitrogen atoms present in the compounds.

For purposes of the present invention the terms fabric enhancer and fabric conditioner are used interchangeably.

The term “fabric care” is used herein the broadest sense to include any conditioning benefit(s) to fabric. One such conditioning benefit includes softening fabric. Other non-limiting conditioning benefits include reduction of abrasion, reduction of wrinkles, fabric feel, garment shape retention, garment shape recovery, elasticity benefits, ease of ironing, perfume, freshness, color care, color maintenance, whiteness maintenance, increased whiteness and brightness of fabrics, pilling reduction, static reduction, antibacterial properties, suds reduction (especially in high efficiency, horizontal axis washing machines), malodor control, or any combination thereof.

One aspect of the invention provides fabric care compositions suitable for dosing, for example, into a washing machine. In one embodiment, a fabric enhancer composition comprises: a. a cationic polymer; b. less than about 20% silicone; and c. a deposition aid wherein the composition is essentially free of a coacervate.

While wishing not to be bound by theory, it is believed that while coacervates are useful for improving deposition of silicone, emulsions, perfume, and other materials; in the present invention, cationic surfactant (one example being cationic ammonium compounds) is effectively used to provide a softness feel to fabrics. To maintain compatibility (e.g., avoid precipitation) between the fabric softener active and the deposition polymer, a cationic or nonionic deposition polymer is preferred. Typically, when using a cationic polymer, an anionic surfactant is added to form a coacervate phase. However, it is known to those skilled in the art that addition of anionic surfactant to a fabric softening composition comprising cationic surfactant can compromise the softening benefit. Thus, in one embodiment, anionic surfactant is excluded from compositions of the present invention.

### A. Silicone

One aspect of invention comprises a fabric care composition comprising a silicone as a fabric care active. Silicone polymers, not only provide softness and smoothness to fabrics, but also provide a substantial color appearance benefit to fabrics, especially after multiple laundry washing cycles. While not wishing to be bound by theory, it is believed that silicone polymers provide an anti-abrasion benefit to fabrics in the washing or rinse cycles (or both) of an automatic washing machine by reducing friction of the fibers. Garments can look newer longer and can last longer before wearing out.

Levels of silicone will depend, in part, on whether the composition is concentrated or non-concentrated. Typical minimum levels of incorporation of silicone in the present compositions are at least about 0.1%, alternatively at least about 5%, alternatively at least about 10%, and alternatively at least about 20%, by weight of the fabric care composition; and the typical maximum levels of incorporation of silicone are less than about 90%, alternatively less than about 70%, by weight of the fabric care composition.

In one embodiment, the composition is a concentrated composition comprising from about 5% to about 90%, alternatively from about 8% to about 70%, alternatively about 9% to about 30%, alternatively from about 10% to 25%, alternatively from about 15% to about 24%, silicone by weight of the fabric care composition.

In another embodiment, the composition is a non-concentrated composition comprising from about 0.5% to about 30%, alternatively from about 2% to about 20%, alternatively 4% to about 10%, silicone by weight of the composition.

The silicone of the present invention can be any silicone comprising compound. In one embodiment, the silicone is a polydialkylsilicone, alternatively a polydimethyl silicone (polydimethyl siloxane or “PDMS”), or a derivative thereof. In another embodiment, the silicone is chosen from an aminofunctional silicone, alkyloxylated silicone, ethoxylated silicone, propoxylated silicone, ethoxylated/propoxylated silicone, quaternary silicone, or combinations thereof. Other useful silicone materials may include materials of the formula:

HO[Si(CH₃)₂—O]ₓ{Si(OH)[(CH₂)₃—NH—(CH₂)₂—NH₂]O}_{y}H

wherein x and y are integers which depend on the molecular weight of the silicone, preferably has a molecular weight such that the silicone exhibits a viscosity of from about 500 cSt to about 500,000 cSt at 25° C. This material is also known as “amodimethicone”. Although silicones with a high number of amine groups, e.g., greater than about 0.5 millimolar equivalent of amine groups can be used, they are not preferred because they can cause fabric yellowing.

In one embodiment, the silicone is one comprising a relatively high molecular weight. A suitable way to describe the molecular weight of a silicone includes describing its viscosity. A high molecular weight silicone is one having a viscosity of from about 1,000 cSt to about 3,000,000 cSt, preferably from about 6,000 cSt to about 1,000,000 cSt, alternatively about 7,000 cSt to about 1,000,000 cSt, alternatively 8,000 cSt to about 1,000,000 cSt, alternatively from about 10,000 cSt to about 600,000 cSt, alternatively from about 100,000 cSt to about 350,000 cSt. In yet another embodiment, the silicone is a PDMS or derivatives thereof, having a viscosity from about 30,000 cSt to about 600,000 cSt, alternatively from about 75,000 cSt to about 350,000 cSt, and alternatively at least about 100,000 cSt. One example of a PDMS is DC 200 fluid from Dow Corning. In yet another embodiment, the viscosity of the aminofunctional silicone can be low (e.g., from about 50 cSt to about 100,000 cSt).

For purposes of describing the present invention, any method can be used to measure the viscosity of the silicone. One suitable method is the “Cone/Plate Method” as described herein. The viscosity is measured by a cone/plate viscometer (such as Wells—Brookfield cone/plate viscometer by Brookfield Engineering Laboratories, Stoughton, Mass.). Using the Cone/Plate Method, the spindle is “CP-52” and the revolutions per minute (rpm) is set at 5. The viscosity measurement is conducted at 25° C. Under the Cone/Plate Method, a typical PDMS fluid measured at about 100,000 cSt will have an average molecular weight of about 139,000. Without wishing to be bound by theory, the high molecular weight silicone is more viscous and is less easily rinsed off of the fabrics in the washing and/or rinsing cycles of an automatic washing machine.

Another aspect of the invention provides a fabric care composition comprising a silicone emulsion. In one embodiment, the compositions of the present invention comprise a first phase, a second phase and an effective amount of an emulsifier such that the second phase forms discrete droplets in the continuous first phase. The second phase, or dispersed phase, comprises at least one fabric care active (such as a silicone). The dispersed phase may also contain other fabric are actives (such as, but not limited to, a static control agent and/or a perfume). Additionally, the first phase may also contain at least one fabric care active (such as a hueing dye). Alternatively, there may be several dispersed phases containing fabric care actives.

In one embodiment, if the fabric care active is a liquid, for example a silicone liquid, the second phase may form discrete droplets having a defined χ₅₀. In turn, “χ₅₀” is herein defined as the median diameter of a particle (measured in micrometers) on a volumetric basis. For example, if the χ₀ is 1000 μm, then about 50% by volume of the particles are smaller than this diameter and about 50% are larger. In one embodiment, the droplets forming the second phase have a χ₅₀ of less than about 1000 μm, alternatively less than about 500 μm, alternatively less than about 100 μm; alternatively at least about 0.1 μm, alternatively at least about 1 μm, alternatively at least about 2 μm, alternatively less than about 10 μm. For purposes of describing the present invention, any method can be used to measure the χ₅₀ of the droplets comprising the second phase, for example laser light scattering using a Horiba LA900 Particle Size Analyzer. One suitable method is described by the International Standard test method ISO 13320-1:1999(E) for Particle Size Analysis—Laser Diffraction Methods.

While not wanting to be bound by theory, it is believed that silicone particles smaller that about 0.1 μm are too fine to be effectively trapped in the fabrics during the wash cycle and silicone particles larger than about 1000 μm provide poor distribution of active on fabric, resulting in less optimal benefits and even possible fabric spotting or staining. In one embodiment, the silicone particles from about 0.2 μm to about 50 μm. In on embodiment, the silicone particles from about 1 μm to about 30 μm in diameter. One aspect of the invention provides a fabric care composition comprising a PDMS and/or an aminofunctional silicone. For the aminofunctional silicone (also defined as “aminosilicone”), it is preferred to have a viscosity of from about 50 cSt to about 1,500,000 cSt, preferably from about 100 cSt to about 1,000,000 cSt, alternatively about 500 cSt to about 500,000 cSt, alternatively 1,000 cSt to about 350,000 cSt, alternatively from about 1,500 cSt to about 100,000 cSt. In one embodiment, the PDMS and aminofunctional silicone are combined. It is preferred that the viscosity of a combination of PDMS and aminofunctional silicone be from about 500 cSt to about 100,000 cSt. For example, improved fabric care benefits may be achieved by combining the PDMS to aminofunctional silicone in a ratio from about 6:1 to about 1:3, alternatively from about 5:1 to about 1:1, alternatively from about 4:1 to about 2:1, respectively. In another embodiment, the PDMS to aminofunctional silicone ratio is combined in about 3:1 ratio before being incorporated as part of the fabric care composition.

One aspect of this invention is based upon the surprising discovery that high molecular weight PDMS, verses low molecular weight PDMS, may be more effective in softening fabric. However, high molecular weight PDMS is viscous and thus difficult to handle from a processing perspective. Adding the viscous PDMS and an emulsifier into the composition can result in inhomogeneous mixing of the ingredients. Surprisingly, by using a high internal phase emulsion (“HIPE”) as a premix, processing advantages are achieved. That is, by premixing a silicone, such as PDMS, and the emulsifier to create a HIPE, then mixing this HIPE into the composition, good mixing may be achieved thereby resulting in a homogeneous mixture. Net, a composition that exhibits good fabric benefits can be achieved.

HIPEs generally are comprised of at least about 65%, alternatively at least about 70%, alternatively at least about 74%, alternatively at least about 80%; alternatively not greater than about 95%, by weight of an internal phase (dispersed phase), wherein the internal phase comprises a silicone. The internal phase can also be other water insoluble fabric care benefit agents that are not already pre-emulsified. Pre-emulsified water insoluble fabric care benefit agents, for example, as discussed in the next section entitled “Other Water Insoluble Fabric Care Benefit Agents”, can be used without the need to form a HIPE. The internal phase is dispersed by using an emulsifying agent. Examples of the emulsifying agent include a surfactant or a surface tension reducing polymer. In one embodiment, the range of the emulsifying agent is from at least about 0.1% to about 25%, alternatively from about 1% to about 10%, and alternatively from about 2% to about 6% by weight of the HIPE. In another embodiment, the emulsifying agent is water soluble and reduces the surface tension of water, at a concentration less than of 0.1% by weight of deionized water, less than about 70 dynes, alternatively less than about 60 dynes, alternatively less than about 50 dynes; alternatively at or greater than about 20 dynes. In another embodiment, the emulsifying agent is at least partially water insoluble.

The external phase (continuous phase), in one embodiment, is water, alternatively comprises at least some water, alternatively comprises little or no water. In another embodiment, the external phase of water comprises from less than about 35%, alternatively less than about 30%, alternatively less than about 25%; alternatively at least about 1%, by weight of HIPE. Non-aqueous HIPEs can be prepared as well with a solvent as the external phase with low or no water present. Typical solvents include glycerin and propylene glycol. Other solvents are listed in the “Solvents” section of the present disclosure.

HIPEs are prepared by first combining the oil phase (internal phase) and the emulsifying agent. Then the external phase (e.g., water or solvent or a mixture thereof) is added slowly with moderate mixing to the combination of the oil phase and the emulsifying agent. As a general principle, the thinner (i.e., less viscous) the oil phase, the more important it is to add the external phase (e.g., water) slowly. At least one way to test the quality of the HIPE is to simply add the HIPE to water—if it readily disperses in water, then it is a good water continuous HIPE. If the HIPE does not disperse readily, then the HIPE may be improperly formed. When making a HIPE with a thick oil external phase, for example a PDMS at 100K cSt (100K cSt means 100,000 cSt), then it may be possible to mix the oil phase, emulsifying agent, and external phase all together at the same time and mix slowly by modest agitation. A HIPE may be easily formed with this procedure. An advantage to a HIPE, compared to a conventional emulsion, is that a HIPE may allow for processing with a relatively low amount of water. Such a low amount of water may be useful for unit dose executions of the present invention, wherein, for example, fabric care compositions are contained in a water soluble sachet comprised of polyvinyl alcohol (“PVOH”) film. Such PVOH films generally require a relatively low level of water. In one embodiment, the concentrated fabric care composition comprises from about 0% to about 20%, alternatively from about 5% to about 15%, alternatively from about 8% to about 13% of water by weight of the fabric care composition.

In one embodiment, the composition is a highly concentrated composition. A high internal phase emulsion of silicone that is water continuous is prepared before addition to the rest of the formulation.

In another embodiment, the composition is a non-concentrated composition. In this embodiment, the silicone is not, at least initially, emulsified, i.e., the silicone can be emulsified in the fabric care composition itself.

In yet another embodiment, the fabric care composition is free or essentially free of a silicone.

### B. Other Water Insoluble Fabric Care Benefit Agents

In addition to or in lieu of silicone, other materials can be used as well as fabric care benefit agents. Non-limiting examples of these other agents include: fatty oils, fatty acids, soaps of fatty acids, fatty triglycerides, fatty alcohols, fatty esters, fatty amides, fatty amines; sucrose esters, dispersible polyethylenes, polymer latexes, and clays.

Nonionic fabric care benefit agents can comprise sucrose esters, and are typically derived from sucrose and fatty acids. Sucrose ester is composed of a sucrose moiety having one or more of its hydroxyl groups esterified.

Sucrose is a disaccharide having the following formula:

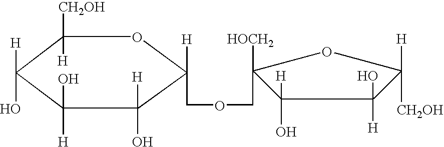

Alternatively, the sucrose molecule can be represented by the formula: M(OH)₈, wherein M is the disaccharide backbone and there are total of 8 hydroxyl groups in the molecule.

Thus, sucrose esters can be represented by the following formula:

M(OH)₈₋ₓ(OC(O)R¹)ₓ

wherein x is the number of hydroxyl groups that are esterified, whereas (8-x) is the hydroxyl groups that remain unchanged; x is an integer selected from 1 to 8, alternatively from 2 to 8, alternatively from 3 to 8, or from 4 to 8; and R¹ moieties are independently selected from C₁-C₂₂ alkyl or C₁-C₃₀ alkoxy, linear or branched, cyclic or acyclic, saturated or unsaturated, substituted or unsubstituted.

In one embodiment, the R¹ moieties comprise linear alkyl or alkoxy moieties having independently selected and varying chain length. For example, R¹ may comprise a mixture of linear alkyl or alkoxy moieties wherein greater than about 20% of the linear chains are C₁₈, alternatively greater than about 50% of the linear chains are C₁₈, alternatively greater than about 80% of the linear chains are C₁₈.

In another embodiment, the R¹ moieties comprise a mixture of saturate and unsaturated alkyl or alkoxy moieties; the degree of unsaturation can be measured by “Iodine Value” (hereinafter referred as “IV”, as measured by the standard AOCS method). The IV of the sucrose esters suitable for use herein ranges from about 1 to about 150, or from about 2 to about 100, or from about 5 to about 85. The R¹ moieties may be hydrogenated to reduce the degree of unsaturation. In the case where a higher IV is preferred, preferably from about 40 to about 95, then oleic acid and fatty acids derived from soybean oil and canola oil are the preferred starting materials.

In a further embodiment, the unsaturated R¹ moieties may comprise a mixture of “cis” and “trans” forms about the unsaturated sites. The “cis”/“trans” ratios may range from about 1:1 to about 50:1, or from about 2:1 to about 40:1, or from about 3:1 to about 30:1, or from about 4:1 to about 20:1.

Non-limiting examples of water insoluble fabric care benefit agents include dispersible polyethylene and polymer latexes. These agents can be in the form of emulsions, latexes, dispersions, suspensions, and the like. Preferably they are in the form of an emulsion or a latex. Dispersible polyethylenes and polymer latexes can have a wide range of particle size diameters (χ₅₀) including but not limited to from about 1 nm to about 100 um; alternatively from about 10 nm to about 10 um. As such, the preferred particle sizes of dispersible polyethylenes and polymer latexes are generally, but without limitation, smaller than silicones or other fatty oils.

### Dispersible Polyolefins

Generally, all dispersible polyolefins that provide fabric care benefits can be used as water insoluble fabric care benefit agents in the present invention. The polyolefins can be in the format of waxes, emulsions, dispersions or suspensions. Non-limiting examples are discussed below.

In one embodiment, the polyolefin is chosen from a polyethylene, polypropylene, or a combination thereof. The polyolefin may be at least partially modified to contain various functional groups, such as carboxyl, alkylamide, sulfonic acid or amide groups. In another embodiment, the polyolefin is at least partially carboxyl modified or, in other words, oxidized.

For ease of formulation, the dispersible polyolefin may be introduced as a suspension or an emulsion of polyolefin dispersed by use of an emulsifying agent. The polyolefin suspension or emulsion preferably comprises from about 1% to about 60%, alternatively from about 10% to about 55%, alternatively from about 20% to about 50% by weight of polyolefin. The polyolefin preferably has a wax dropping point (see ASTM D3954-94, volume 15.04—“Standard Test Method for Dropping Point of Waxes”) from about 200 to about 170° C., alternatively from about 50° to about 140° C. Suitable polyethylene waxes are available commercially from suppliers including but not limited to Honeywell (A-C polyethylene), Clariant (Velustrol® emulsion), and BASF (LUWAX®).

When an emulsion is employed with the dispersible polyolefin, the emulsifier may be any suitable emulsification agent. Non-limiting examples include an anionic, cationic, nonionic surfactant, or a combination thereof. However, almost any suitable surfactant or suspending agent may be employed as the emulsification agent. The dispersible polyolefin is dispersed by use of an emulsification agent in a ratio to polyolefin wax of about 1:100 to about 1:2, alternatively from about 1:50 to about 1:5, respectively.

### Polymer Latexes

Polymer latex is made by an emulsion polymerization which includes one or more monomers, one or more emulsifiers, an initiator, and other components familiar to those of ordinary skill in the art. Generally, all polymer latexes that provide fabric care benefits can be used as water insoluble fabric care benefit agents of the present invention. Non-limiting examples of suitable polymer latexes include those disclosed in WO 02/18451; US 2004/0038851 A1; and US 2004/0065208 A1. Additional non-limiting examples include the monomers used in producing polymer latexes such as: (1) 100% or pure butylacrylate; (2) butylacrylate and butadiene mixtures with at least 20% (weight monomer ratio) of butylacrylate; (3) butylacrylate and less than 20% (weight monomer ratio) of other monomers excluding butadiene; (4) alkylacrylate with an alkyl carbon chain at or greater than C₆; (5) alkylacrylate with an alkyl carbon chain at or greater than C₆ and less than 50% (weight monomer ratio) of other monomers; (6) a third monomer (less than 20% weight monomer ratio) added into an aforementioned monomer systems; and (7) combinations thereof.

Polymer latexes that are suitable fabric care benefit agents in the present invention may include those having a glass transition temperature of from about −120° C. to about 120° C., alternatively from about −80° C. to about 60° C. Suitable emulsifiers include anionic, cationic, nonionic and amphoteric surfactants. Suitable initiators include initiators that are suitable for emulsion polymerization of polymer latexes. The particle size diameter (so) of the polymer latexes can be from about 1 nm to about 10 μm, alternatively from about 10 nm to about 1 μm, preferably from about 10 nm to about 20 nm.

In one embodiment, the fabric care composition of the present invention is free or essentially free of other water insoluble fabric care benefit agents.

### C. Coacervate Phase

One aspect of this invention provides for a composition essentially free of a coacervate phase. A coacervate is typically an interaction product of a cationic polymer or cationic surfactant and an anionic surfactant. The level of the coacervate in the compositions of the present invention are from about 0.0001% to about 1%, alternatively from about 0.0001% to about 0.005%, and alternatively about 0% by weight of the fabric care composition.

### D. Cationic Polymers

The term “cationic polymer” is used herein the broadest sense to include any polymer (including, in one embodiment, a cationic surfactant) which has a cationic charge. Some cationic polymers can function as deposition aids as described in the next section; or alternatively, provide fabric care benefits on their own such as antiabrasion effects to improve the appearance of colored fabrics.

The fabric care compositions herein can contain from about 0.001% to about 10%, alternatively from about 0.01% to about 5%, alternatively from about 0.1% to about 2%, of cationic polymer, typically having a molecular weight of from about 500 to about 5,000,000 (although some cationic starches can be as high as 10,000,000 in molecular weight), alternatively from about 1,000 to about 2,000,000, alternatively from about 1,000 to about 1,000,000, and alternatively from about 2,000 to about 500,000 and a charge density of at least about 0.01 meq/gm., and up to about 23 meq/gm., alternatively from about 0.05 to about 8 meq/gm., alternatively from about 0.08 to about 7 meq/gm., and even alternatively from about 0.1 to about 1 milliequivalents/gram (meq/gm).

The cationic polymers of the present invention can be amine salts or quaternary ammonium salts. Preferred are quaternary ammonium salts. They include cationic derivatives of natural polymers such as some polysaccharide, gums, starch and certain cationic synthetic polymers such as polymers and copolymers of cationic vinyl pyridine or vinyl pyridinium halides. Preferably the polymers are water-soluble, for instance to the extent of at least 0.5% by weight are soluble in water at 20° C. Preferably the polymers have molecular weights (Daltons) of from about 500 to about 5,000,000, preferably from about 1,000 to about 2,000,000, more preferably from about 1,000 to about 1,000,000, and even more preferably from about 2,000 to about 500,000, and especially from about 2000 to about 100,000. As a general rule, the lower the molecular weight, the higher the degree of substitution (D.S.) by cationic, usually quaternary groups, which is desirable, or, correspondingly, the lower the degree of substitution, the higher the molecular weight which is desirable, but no precise relationship appears to exist. In general, the cationic polymers may have a charge density of at least about 0.01 meq/gm., preferably from about 0.05 to about 8 meq/gm., more preferably from about 0.08 to about 7 meq/gm., and even more preferably from about 0.1 to about 1 meq/gm. Cationic polymers are disclosed in U.S. Pat. No. 6,492,322 at column 6, line 65 to column 24, line 24. Other cationic polymers are disclosed in the CTFA “International Cosmetic Ingredient Dictionary and Handbook,” Tenth Edition, Tara E. Gottschalck and Gerald N. McEwen, Jr., editors, published by The Cosmetic, Toiletry, and Fragrance Association, 2004. Still other cationic polymers are described at U.S. Patent Publication 2003-0139312 A1, published Jul. 24, 2003, from paragraph 317 to paragraph 347. The list of the cationic polymers includes the following.

In one embodiment, the cationic polymer comprises a polysaccharide gum. Of the polysaccharide gums, guar and locust bean gums, which are galactomannam gums are available commercially, and are preferred. In another embodiment, the cationic polymer comprises cationic guar gum. Guar gums are marketed under Trade Names CSAA M/200, CSA 200/50 by Meyhall and Stein-Hall, and hydroxyalkylated guar gums are available from the same suppliers. Other polysaccharide gums commercially available include: Xanthan Gum; Ghatti Gum; Tamarind Gum; Gum Arabic; and Agar. Cationic guar gums under the Trade Name N-Hance are available from Aqualon.

Suitable cationic starches and derivatives are the natural starches such as those obtained from maize, wheat, barley etc., and from roots such as potato, tapioca etc., and dextrins, particularly the pyrodextrins such as British gum and white dextrin.

Some preferred individual cationic polymers are the following: Polyvinyl pyridine, molecular weight about 40,000, with about 60% of the available pyridine nitrogens quaternized; copolymer of 70/30 molar proportions of vinyl pyridine/styrene, molecular weight about 43,000, with about 45% of the available pyridine nitrogens quaternized as above; copolymers of 60/40 molar proportions of vinyl pyridine/acrylamide, with about 35% of the available pyridine nitrogens quaternized as above; copolymers of 77/23 and 57/43 molar proportions of vinyl pyridine/methyl methacrylate, molecular weight about 43,000, with about 97% of the available pyridine nitrogens quaternized as above. These cationic polymers are effective in the compositions at very low concentrations for instance from 0.001% by weight to 0.2% especially from about 0.02% to 0.1% by weight of the fabric care composition.

Some other cationic polymers include: copolymer of vinyl pyridine and N-vinyl pyrrolidone (63/37) with about 40% of the available pyridine nitrogens quaternized; copolymer of vinyl pyridine and acrylonitrile (60/40), quaternized as above; copolymer of N,N-dimethyl amino ethyl methacrylate and styrene (55/45) quaternized as above at about 75% of the available amino nitrogen atoms; and Eudragit E™ (Rohm GmbH) quaternized as above at about 75% of the available amino nitrogens. Eudragit E™ is believed to be copolymer of N,N-dialkyl amino alkyl methacrylate and a neutral acrylic acid ester, and to have molecular weight about 100,000 to 1,000,000. Another example of a cationic polymer includes a copolymer of N-vinyl pyrrolidone and N,N-diethyl amino methyl methacrylate (40/50), quaternized at about 50% of the available amino nitrogens. These cationic polymers can be prepared in a known manner by quaternizing the basic polymers.

Other useful cationic polymer examples include Magnafloc 370 (from Ciba Specialty Chemicals) also know by the CTFA name as Polyquaternium-6, as well as Polyquaternium-10 and Polyquaternium-24 (from Amerchol Corporation), and polyvinylamine also known as Lupamin (e.g., Lupamin 1595 and Lupamin 5095 from BASF). Magnafloc 370 has a relatively high charge density of about 6 meq/g. Lupamins can have molecular weights from about 10,000 to about 20,000 and a very high charge density of about 23 meq/g. Other examples of cationic polymers are chitosan, oligochitosan (preferred are materials with a molecular weight from about 500 to about 2,000,000, more preferably from about 500 to about 50,000; a degree of acetylation of from about 70% and lower; and a polydispersity of from about 0 to about 10, preferably from about 1 to about 3), chitosan derivatives, quaternized chitosan, and Syntahlen CR (Polyquaternium-37) available from 3V.

Further examples of cationic polymers include cationic polymeric salts such as quaternized polyethyleneimines. These have at least 10 repeating units, some or all being quaternized. Commercial examples of polymers of this class are also sold under the generic Trade Name Alcostat™ by Allied Colloids. Typical examples of cationic polymers are disclosed in U.S. Pat. No. 4,179,382 to Rudkin, et. al., column 5, line 23 through column 11, line 10. Each polyamine nitrogen whether primary, secondary or tertiary, is further defined as being a member of one of three general classes; simple substituted, quaternized or oxidized. The polymers are made neutral by water-soluble anions such as chlorine (Cl⁻), bromine (Br⁻), iodine (I⁻) or any other negatively charged radical such as sulfate (SO₄²⁻) and methosulfate (CH₃SO₃—). Specific polyamine backbones are disclosed in U.S. Pat. Nos. 2,182,306; 3,033,746; 2,208,095; 2,806,839; 2,553,696. An example of modified polyamine cationic polymers of the present invention comprising PEI's comprising a PEI backbone wherein all substitutable nitrogens are modified by replacement of hydrogen with a polyoxyalkyleneoxy unit, —(CH₂CH₂O)₇H. Other suitable polyamine cationic polymers comprise this molecule which is then modified by subsequent oxidation of all oxidizable primary and secondary nitrogens to N-oxides and/or some backbone amine units are quaternized, e.g. with methyl groups.

Preferred cationic polymers include cationic guar gums and cationic cellulose polymers. The preferred cationic guar gums include the N-Hance® 3000 series from Aqualon (N-Hance® 3000, 3196, 3198, 3205, and 3215). These have a range of charge densities from about 0.07 to about 0.95 meq/gm. Another effective cationic guar gum is Jaguar C-13S. Cationic guar gums are a highly preferred group of cationic polymers in compositions according to the present invention and act both as scavengers for residual anionic surfactant (if used in the rinse cycle) and also add to the softening effect of cationic textile softeners even when used in baths containing little or no residual anionic surfactant. The other polysaccharide-based gums can be quaternized similarly and act substantially in the same way with varying degrees of effectiveness. Cationic guar gums and methods for making them are disclosed in British Pat. No. 1,136,842 and U.S. Pat. No. 4,031,307. Preferably cationic guar gums have a D.S. of from about 0.1 to about 0.5.

Some highly preferred cationic guar gums and their physical properties are shown below:

| | | | | | Degree of |
|---|---|---|---|---|---|
| Cationic Polymer | Supplier | MW | Viscosity | | Substitution |
| Meypro-Coat 21 | Rhodia | 50K | 100 | (3%) | 0.1 |
| N-Hance 3269 | Aqualon | 500K | 25-65 | (1%) | 0.13 |
| Jaguar Exel | Rhodia | na | 500 | (1%) | 0.1 |
| N-Hance 3000 | Aqualon | 1200K | 1000-2000 | (1%) | 0.07 |
| N-Hance 3196 | Aqualon | 1600K | 4000-5000 | (1%) | 0.13 |
| Jaguar C-13S | Rhodia | 2000K | 3000 | (1%) | 0.13 |
| Jaguar C-17 | Rhodia | 2000K | 3000 | (1%) | 0.17 |
| N-Hance 3215 | Aqualon | 1500K | 3200-4200 | (1%) | 0.20 |

Cationic hydroxypropyl guars can also be use as cationic deposition aids, but may give somewhat lower performance. Useful examples include Jaguar C-162 and Jaguar C-2000 (ex. Rhodia).

Cationic cellulose polymers can also be used and another preferred class of materials. Included are “amphoteric” polymers of the present invention since they will also have a net cationic charge, i.e.; the total cationic charges on these polymers will exceed the total anionic charge. The degree of substitution of the cationic charge can be in the range of from about 0.01 (one cationic charge per 100 polymer repeating units) to about 1.00 (one cationic charge on every polymer repeating unit) and preferably from about 0.01 to about 0.20. The positive charges could be on the backbone of the polymers or the side chains of polymers.

While there are many ways to calculate the charge density of cationic celluloses, the degree of substitution of the cationic charge can be simply calculated by the cationic charges per 100 glucose repeating units. One cationic charge per 100 glucose repeating units equals to 1% charge density of the cationic celluloses.

Preferred cationic celluloses for use herein include those which may or may not be hydrophobically-modified, having a molecular weight (Dalton) of from about 50,000 to about 2,000,000, more preferably from about 100,000 to about 1,000,000, and most preferably from about 200,000 to about 800,000. These cationic materials have repeating substituted anhydroglucose units that correspond to the general Structural Formula I as follows:

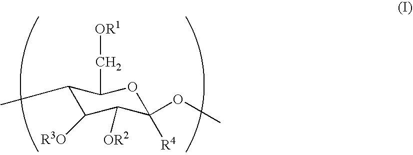

wherein R¹, R², R³ are each independently H, CH₃, C₈₋₂₄ alkyl (linear or branched),

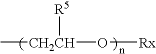

or mixtures thereof; wherein n is from about 1 to about 10; Rx is H, CH₃, C₈₋₂₄ alkyl (linear or branched)

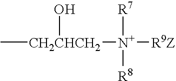

or mixtures thereof, wherein Z is a water soluble anion, preferably a chlorine ion and/or a bromine ion; R⁵ is H, CH₃, CH₂CH₃, or mixtures thereof; R⁷ is CH₃, CH₂CH₃, a phenyl group, a C₈₋₂₄ alkyl group (linear or branched), or mixture thereof; and
R⁸ and R⁹ are each independently CH₃, CH₂CH₃, phenyl, or mixtures thereof:

### R⁴ is H,

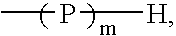

or mixtures thereof wherein P is a repeat unit of an addition polymer formed by radical polymerization of a cationic monomer such as

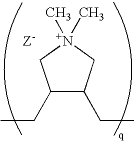

wherein Z′ is a water-soluble anion, preferably chlorine ion, bromine ion or mixtures thereof and q is from about 1 to about 10.

The charge density of the cationic celluloses herein (as defined by the number of cationic charges per 100 glucose units) is preferably from about 0.5% to about 60%, more preferably from about 1% to about 20%, and most preferably from about 2% to about 10%.

Alkyl substitution on the anhydroglucose rings of the polymer ranges from about 0.01% to about 5% per glucose unit, more preferably from about 0.05% to about 2% per glucose unit, of the polymeric material.

The cationic cellulose ethers of Structural Formula I likewise include those which are commercially available and further include materials which can be prepared by conventional chemical modification of commercially available materials. Commercially available cellulose ethers of the Structural Formula I type include the JR 30M, JR 400, JR 125, LR 400 and LK 400 polymers, all of which are marketed by Dow Chemical.

Another example of a cationic polymer is a cationic polysaccharide, preferably starch, compound. The terms “polysaccharide” and “cationic starch” are used herein in the broadest sense. A cationic starch can also be used as a fabric care active, e.g., for softness and conditioning. Cationic starches are described in U.S. Pat. Pub. 2004/0204337 A1.

In one embodiment, the fabric care composition is free or essentially free of a cationic polymer.

### E. Deposition Aid

The fabric care composition may also comprise deposition aids including, but not limited to I) non-quaternary materials that are (a) acyclic polymers or copolymers having nitrogen moieties in the backbone or in the pendant groups, or (b) vinyl polymers or copolymers having nitrogen heterocyclics in the pendant groups; II) non-polysaccharide polyquaterniums and other polymeric cationic quaternary materials; and mixtures thereof. The deposition aid improves the deposition of a fabric care active with some examples being silicone or other insoluble actives.

The deposition aids suitable for use herein are polymeric materials having a weight average molecular weight generally in the range from about 1000 to about 1,000,000, or from about 1000 to about 200,000, or from about 2500 to about 1,000,000, or from about 5000 to about 500,000. In some embodiments, the deposition aid is polyacrylamide or derivatives thereof, the weight average molecular weight of the deposition aid is from about 1,000,000 to about 15,000,000.

When present, each deposition aid comprises, based on total composition weight, at one of the following levels, from about 0.1% to about 20%, preferably from about 0.2% to about 15%, more preferably from about 0.2% to about 10 wt %, and most preferably from about 0.2% to about 5%.

In some embodiments of the present invention, suitable deposition aids are acyclic polymers or copolymers derived from monomers having nitrogen moieties, including but not limited to, amine, imine, amide, imide, acrylamide, methacrylamide, amino acid, and mixtures thereof. Nonlimiting examples of suitable deposition aids are described below:

### Acyclic Polymers or Copolymers Having Nitrogen Moieties

### a) Polyvinylamine (PVAm)

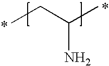 [0072] Examples of this polymeric material are available as Catiofast® PR8085, PR8106, PR8134, Lupamin® all of which are from BASF and are typically used as cross-linking agents or flocculating agents in paper-making industry.

### b) Polyethyleneimine (PEI)

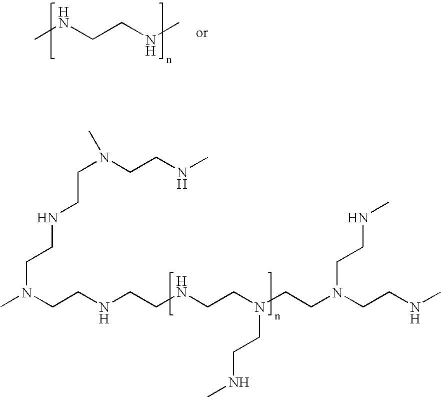 [0074] Examples of this polymeric material are available as Lupasol® and Polymin® from BASF, or as Catiofast® PL, SF, GM, PR8138, all of which are from BASF and are typically used as cross-linking agents or flocculating agents in paper-making industry.

### c) Grafted and Crosslinked PolyAmido-Polyethyleneimine

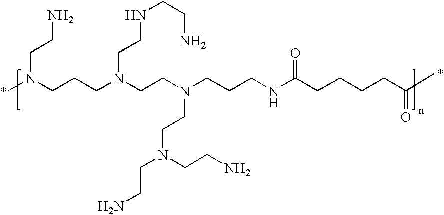

### d) Ethoxylated Polyethyleneimine (PEI-E)

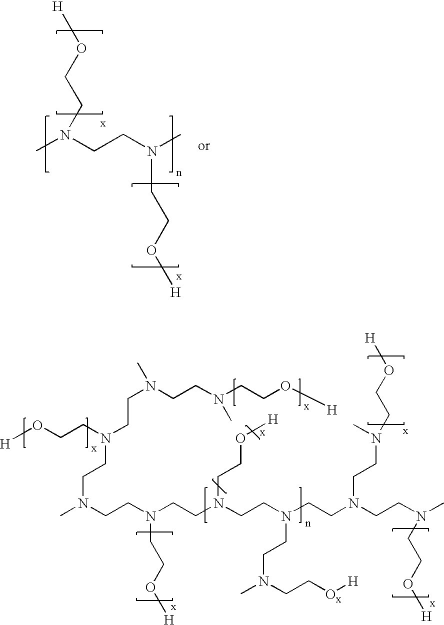 [0077] wherein, x=140

### e) Polyacrylamide

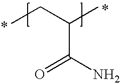

### f) Poly(2-dimethylaminoethyl methacrylate)

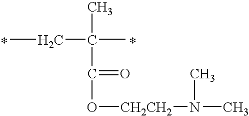

### g) Poly(amino acids): for Example, Polylysine would have the Following Formula

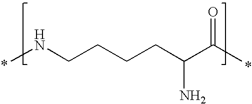 [0081] additional examples of poly(amino acids) are selected from the group consisting of:
(1) homo-condensates of basic amino acids, said amino acids selected from the group consisting of lysine, ornithine, arginine, and tryptophan;
(2) co-condensates of basic amino acids, said amino acids selected from the group consisting of lysine, ornithine, arginine, and tryptophan;
(3) co-polymers produced from the reaction of one or more basic amino acids with one or more co-condensable compounds;
(4) co-polymers produced from the reaction of one or more homo-condensates from (1) or co-condensates from (2) with one or more co-condensable compounds;
(5) crosslinked basic amino acid-containing polymers, said crosslinked polymers comprising:
   i) one or more basic amino acids;
   ii) co-polymers of (i) and one or more co-condensable compounds;
   iii) optionally co-polymers produced from the reaction of one or more homo-condensates from (1) or co-condensates from (2) with one or more co-condensable compounds; and
   iv) one or more crosslinking unit;
wherein at least one crosslinking unit is derived from a crosslinker which comprises at least two functional groups;
(6) co-condensates formed from the reaction of one or more compounds selected from the group consisting of:
   i) basic amino acids;
   ii) co-condensable compounds;
   iii) crosslinking agents; and
(7) mixtures thereof.

### h) Polylysine Aminocaproic Acid Derivatives

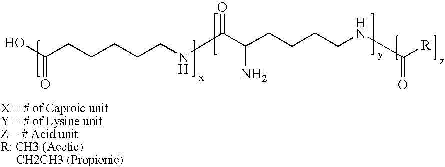

### Vinyl Polymers or Copolymers Having Nitrogen Heterocyclic Pendant Moieties

In some embodiments of the present invention, suitable deposition aids are vinyl polymers or copolymers derived from vinyl monomers having nitrogen heterocyclic pendant moieties having the formula:

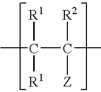

wherein R¹, R² are independently hydrogen, halogen, linear or cyclic, saturated or unsaturated C₁-C₄ alky or alkoxy, substituted or unsubstituted phenyl, benzyl, naphthayl or hetrocyclics, and mixtures thereof; Z is nitrogen heterocyclics, including nitrogen heterocyclic N-oxides.

Nonlimiting examples of these deposition aids are described below:

### a) Polyvinylpyrrolidone (PVP)

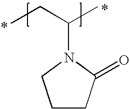

### b) Polyvinylpyridine

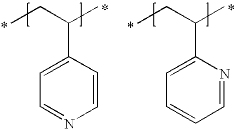

### c) Polyvinylpyridine-N-oxide (PVNO)

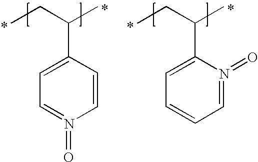

### d) Polyvinylpyrrolidone Vinyl Imadazole (PVPVI)

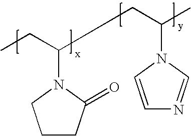

### e) Copolymers of Vinylpyrrolidone and Dimethylaminoethyl Methacrylate

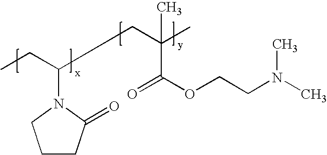

### Non-Polysaccharide Polyquaterniums and Other Polymeric Cationic Quaternary Materials

In some embodiments of the present invention, suitable deposition aids are non-polysaccharide polyquaterniums, other polymeric cationic quaternary materials or mixtures thereof. As used herein, the term “polyquaternium-x” has the same meaning as that of INCI (International Nomenclature Cosmetic Ingredient). These cationic quaternary materials can be paired with anions, including but not limited to halogen or SO₃CH₃⁻. Nonlimiting examples of these deposition aids are described below:

### a) Polyquaternium-2

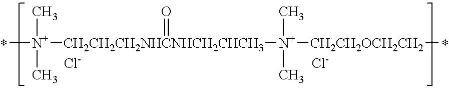 [0107] Examples of this polymeric material are available as Mirapol® A-15 (from Rhodia)

### b) Polyquaternium-6: N,N-Dimethyl-N-2-propen-1-ammonium chloride homopolymer (PDADMAC)

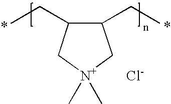 [0109] Examples of this polymeric material are available as Merquat® 100 (from Nalco), Percol® 370 or Magnafloc® 370 (from CIBA)

### c) Polyquaternium-7: Copolymer of acrylamide and N,N-Dimethyl-N-2-propen-1-ammonium chloride

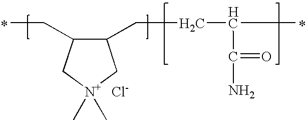 [0111] Examples of this polymeric material are available as Merquat® 550 (from Nalco) or Mirapol® 550 (from Rhodia)

### d) Polyquaternium-11: Quaternized Poly(vinylpyrrolidone/Dimethylaminoethyl Acrylate

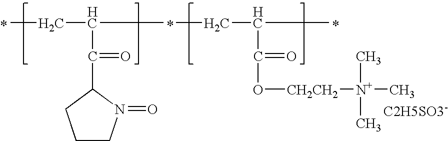 [0113] Examples of this polymeric material are available as Gafquat® 755, 755N, 734 (from ISP)

### e) Polyquaternium-16: Copolymer of Polyvinylpyrrolidone and imidazolinium methochloride

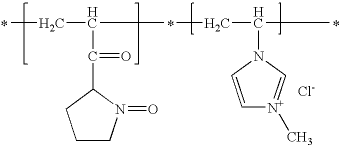 [0115] Examples of this polymeric material are available as Luviquat® FC and Luviquat® HM (from BASF).

### f) Polyquaternium-17: examples of this polymeric material are available as Mirapol® AD-1 (from Rhodia)

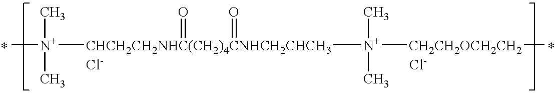

### g) Polyquaternium-18: examples of this polymeric material are available as Mirapol® AZ-1 (from Rhodia)

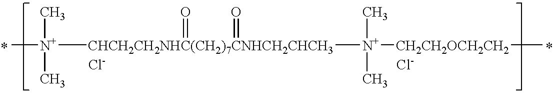

### h) Polyquaternium-22: Copolymer of sodium acrylate and dimethyl diallyl ammonium chloride

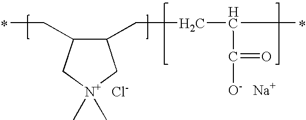 [0119] Examples of this polymeric material are available as Merquat® 280 and 295 (Nalco).

### i) Polyquaternium-28: Copolymer of Vinylpyrrolidone and Methacrylate Amidopropyl/Trimethylammonium Chloride

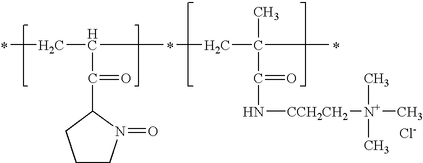 [0121] Examples of this polymeric material are available as Gafquat® HS-100 (ISP)

### j) Cationic Polyacrylamide Such as Polyacrylamide Ethyl Trimethylammonium Cation

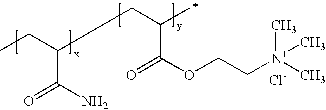 [0123] Examples of this polymeric material are available as Sedipur® CF (from BASF) wherein the cation is paired with a chloride anion.

### k) Poly(2-acryloyloxyethyl)trimethylammonium cation, which may be paired with anion such as methyl sulfate

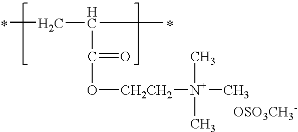

### l) Polymethacrylamidopropyl Trimethylammonium Cation

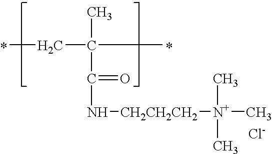 [0126] Examples of this polymeric material are available as Polycare® 133 (from Rhodia), wherein the cation is paired with a chloride anion.

### m) Copolymers which Contain Polyamide, Polyether and Polyethylenimine, Such as

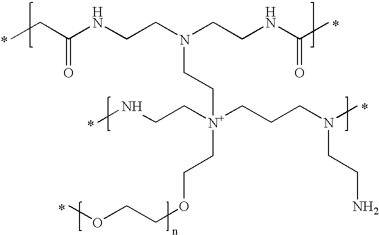

Examples of this polymeric material are available as Polymin® from BASF.

### Additional

### F. Emulsifying and Dispersing Agents

The compositions of the present invention may contain a dispersing agent or an emulsifying agent to (1) form a conventional silicone emulsion or a high internal phase emulsion (“HIPE”) silicone emulsion and/or (2) help disperse the composition.

Other useful surfactants may include nonionics, cationics, zwitterionics, ampholytic surfactants, and mixtures thereof. These surfactants are emulsifers for the silicone and may also help disperse the composition in the wash cycle. In an alternative embodiment, the HIPE or silicone emulsion is free or substantially free of any one or more of these surfactants. In one embodiment, the fabric care compositions are essentially free of anionic surfactants.

Nonionic Surfactants

Suitable nonionic surfactants useful herein for either emulsification of the silicone polymer or dispersing the composition in the wash (or both) can comprise any of the conventional nonionic surfactant types typically used in liquid and/or solid detergent products. These include alkoxylated fatty alcohols and amine oxide surfactants.

Suitable nonionic surfactants for use herein include the alcohol alkoxylate nonionic surfactants. Alcohol alkoxylates are materials which correspond to the general formula: R¹(CₘH₂ₘO)ₙOH wherein R¹ is a C₈-C₁₆ alkyl group, m is from 2 to 4, and n ranges from about 2 to 12. Preferably R¹ is an alkyl group, which may be primary or secondary, that contains from about 9 to 15 carbon atoms, more preferably from about 10 to 14 carbon atoms. In one embodiment, the alkoxylated fatty alcohols will also be ethoxylated materials that contain from about 2 to 12 ethylene oxide moieties per molecule, more preferably from about 3 to 10 ethylene oxide moieties per molecule.

The alkoxylated fatty alcohol materials useful in the detergent compositions herein will frequently have a hydrophilic-lipophilic balance (HLB) which ranges from about 3 to 17. More preferably, the HLB of this material will range from about 6 to 15, most preferably from about 8 to 15. Alkoxylated fatty alcohol nonionic surfactants have been marketed under the tradenames Neodol and Dobanol by the Shell Chemical Company.

Another suitable type of nonionic surfactant useful herein comprises the amine oxide surfactants. Amine oxides are materials which are often referred to in the art as “semi-polar” nonionics. Amine oxides have the formula:

R(EO)ₓ(PO)_{y}(BO)ₙN(O)(CH₂R′)₂.qH₂O.

In this formula, R is a relatively long-chain hydrocarbyl moiety which can be saturated or unsaturated, linear or branched, and can contain from 8 to 20, preferably from 10 to 16 carbon atoms, and is more preferably C₁₂-C₁₆ primary alkyl. R′ is a short-chain moiety, preferably selected from hydrogen, methyl and —CH₂OH. When x+y+z is different from 0, EO is ethyleneoxy, PO is propyleneneoxy and BO is butyleneoxy. Amine oxide surfactants are illustrated by C₁₂₋₁₄ alkyldimethyl amine oxide.

Non-limiting examples of nonionic surfactants include: a) C₁₂-C₁₈ alkyl ethoxylates, such as, NEODOL® nonionic surfactants from Shell; b) C₆-C₁₂ alkyl phenol alkoxylates wherein the alkoxylate units are a mixture of ethyleneoxy and propyleneoxy units; c) C₁₂-C₁₈ alcohol and C₆-C₁₂ alkyl phenol condensates with ethylene oxide/propylene oxide block polymers such as Pluronic® from BASF; d) C₁₄-C₂₂ mid-chain branched alcohols, BA, as discussed in U.S. Pat. No. 6,150,322; e) C₁₄-C₂₂ mid-chain branched alkyl alkoxylates, BAEₓ, wherein x 1-30, as discussed in U.S. Pat. No. 6,153,577, U.S. Pat. No. 6,020,303 and U.S. Pat. No. 6,093,856; f) Alkylpolysaccharides as discussed in U.S. Pat. No. 4,565,647 Llenado, issued Jan. 26, 1986; specifically alkylpolyglycosides as discussed in U.S. Pat. No. 4,483,780 and U.S. Pat. No. 4,483,779; g) Polyhydroxy fatty acid amides as discussed in U.S. Pat. No. 5,332,528, WO 92/06162, WO 93/19146, WO 93/19038, and WO 94/09099; and h) ether capped poly(oxyalkylated) alcohol surfactants as discussed in U.S. Pat. No. 6,482,994 and WO 01/42408.

Other preferred nonionic surfactants include Planteran 2000, Laureth-7 and Lonza PGE-10-1-L, Neodol 23-9, and Neodol 25-3, or mixtures thereof.

### Cationic Surfactants

Cationic surfactants are well known in the art and non-limiting examples of these include quaternary ammonium surfactants, which can have up to 26 carbon atoms. Additional examples include a) alkoxylate quaternary ammonium (AQA) surfactants as discussed in U.S. Pat. No. 6,136,769; b) dimethyl hydroxyethyl quaternary ammonium as discussed in U.S. Pat. No. 6,004,922; c) polyamine cationic surfactants as discussed in WO 98/35002, WO 98/35003, WO 98/35004, WO 98/35005, and WO 98/35006; d) cationic ester surfactants as discussed in U.S. Pat. Nos. 4,228,042, 4,239,660 4,260,529 and 6,022,844; and e) amino surfactants as discussed in U.S. Pat. No. 6,221,825 and WO 00/47708, specifically amido propyldimethyl amine (APA); f) combinations thereof.

### Zwitterionic Surfactants

Non-limiting examples of zwitterionic surfactants include: derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 to Laughlin et al., issued Dec. 30, 1975 at column 19, line 38 through column 22, line 48, for examples of zwitterionic surfactants; betaine, specific examples include alkyl dimethyl betaine and cocodimethyl amidopropyl betaine, C₈ to C₁₈ (preferably C₁₂ to C₁₈) amine oxides and sulfo and hydroxy betaines, such as N-alkyl-N,N-dimethylammino-1-propane sulfonate where the alkyl group can be C₈ to C₁₈, preferably C₁₀ to C₁₄.

### Ampholytic Surfactants

Non-limiting examples of ampholytic surfactants include: aliphatic derivatives of secondary or tertiary amines, or aliphatic derivatives of heterocyclic secondary and tertiary amines in which the aliphatic radical can be straight- or branched-chain. One of the aliphatic substituents contains at least about 8 carbon atoms, typically from about 8 to about 18 carbon atoms, and at least one contains an anionic water-solubilizing group, e.g. carboxy, sulfonate, sulfate. See U.S. Pat. No. 3,929,678 at col. 19, lines 18-35, for examples of ampholytic surfactants.

### G. Static Control Agents

One aspect of the invention provides for a composition of present invention comprising a static control agent. In one embodiment, the static control agent comprises ion-pair conditioning particles. In turn, these particles may comprise water-insoluble particles comprised of certain amine-organic anion ion-pair complexes and, optionally, certain amine-inorganic anion ion-pair complexes. The primary benefit of these conditioning particles in the present invention is to provide antistatic benefits to fabrics, especially those fabrics dried in a machine dryer. These complexes and other non-complexed materials that provide static control are hereafter called Static Control Agents (SCAs).

Although these complexes provide antistatic benefits to laundry, a problem posed by the use of these ingredients includes incompatibility with use of a perfume. Thus one aspect of the invention is based upon the surprising discovery of separating perfume and these ion-pair complexes before these compositions are administered during the laundry process.

The amine-organic anion ion-pair complexes can be represented by the following formula:

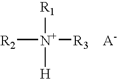

wherein each R₁ and R₂ can independently be C₁₂ to C₂₀ alkyl or alkenyl, and each R₃ is H or CH₃. A represents an organic anion and includes a variety of anions derived from anionic surfactants, as well as related shorter alkyl or alkenyl chain compounds which need not exhibit surface activity. A is selected from the group consisting of alkyl sulfonates, aryl sulfonates, alkylaryl sulfonates, alkyl sulfates, dialkyl sulfosuccinates, alkyl oxybenzene sulfonates, acyl isethionates, acylalkyl taurates, alkyl ethoxylated sulfates, and olefin sulfonates, and mixtures of such anions. A preferred starting material for “A” is cumene sulfonic acid.

As used herein the term alkyl sulfonate shall include those alkyl compounds having a sulfonate moiety at a fixed or predetermined location along the carbon chain, as well as compounds having a sulfonate moiety at a random position along the carbon chain.

The optionally incorporated amine-inorganic anion ion-pair complexes can be represented by the following formula:

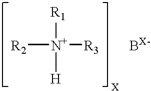

wherein each R₁ and R₂ can independently be C₁₂ to C₂₀ alkyl or alkenyl, each R₃ is H or CH₃, and x corresponds to the molar ratio of the amine to the inorganic anion and the valence of the inorganic anion, x being an integer between 1 and 3, inclusive. B is an inorganic anion such as, but not limited to, sulfate (SO₄²⁻), hydrogen sulfate (HSO₄⁻¹), nitrate (NO₃⁻), phosphate (PO₄⁻³), hydrogen phosphate (HPO₄⁻²), and dihydrogen phosphate (H₂ PO₄⁻¹), and mixtures thereof, preferably sulfate or hydrogen sulfate.

In one embodiment, the SCA is a particle with an average particle diameter of from about 10 to about 500 microns. The term “average particle diameter” represents the mean particle size diameter of the actual particles of a given material. The mean is calculated on a weight percent basis. The mean is determined by conventional analytical techniques such as, for example, laser light diffraction or microscopic determination utilizing a light or scanning electron microscope. For typical manufacturing quality control, the Rotap screening method may be used.

These and other conditioning agent containing amine ion-pair complexes are described in U.S. Pat. Nos. 4,861,502, 5,073,274, 5,019,280, 4,857,213, and 4,913,828 to Debra S. Caswell, et. al., and U.S. Pat. No. 4,915,854, Mao, et. al.

In one embodiment, the ion-pair conditioning particles conditioning agent is chosen from preferred materials listed in U.S. Pat. No. 5,019,280, at columns 4 and 5.

A suitable source for ion-pair SCAs include prills of nominally 70% distearyl amine+cumene sulfonic acid ion pair and 30% bis(distearyl) ammonium sulfate from Degussa. A preferred composition for the SCA is shown below. The particle size by the Rotap method is a median size of about 95 microns, with less than from about 10% to about 25% less than about 53 microns, and less than from about 4% to about 6% greater than about 177 microns. The level of SCA in the compositions of the present invention is from about 1% to about 30%, preferably from about 2% to about 15%.

### Structure of Distearyl Amine+Cumene Sulfonic Acid Ion Pair and Bis(Distearyl)Ammonium Sulfate

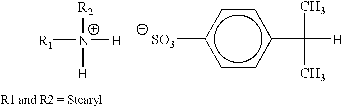

### 70%: Distearyl Amine—Cumene Sulfonic Acid Ion—Pair

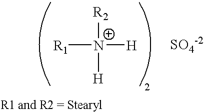

30%: Bis(distearyl)Ammonium Sulfate (sulfate salt of above distearyl protonated amine)

Other useful SCAs include alkyl and dialkyl imidazolines (both protonated and unprotonated) such as, for example, Varisoft 445 Imidazoline (ex. Degussa), polyethylenimines and ethoxylated polyethylenimines (preferred MW from about 2000 to about 25,000). Other cationic polymers may function as antistatic agents, for example Polyquaternium-6. While not wishing to be bound by theory, cationic polymers can function as antistatic agents added through the wash if they are able to maintain at least some cationic charge in or through the rinse cycle.

Still other antistatic agents include dialkyl and monoalkyl cationic surfactants, and combinations of monoalkyl cationic surfactant and fatty acids. Especially preferred are tallow trimethylammonium chloride, cocotrimethylammounium chloride, oleyltrimethylammounium chloride, and lauryltrimethylammonium chloride. Other examples are N,N-di(tallowoyloxyethyl)-N,N-dimethylammonium chloride (available from Akzo under the trade name Armosoft® DEQ), N,N-di(canola-oyloxyethyl)-N,N-dimethylammonium chloride (available from Degussa under the trade name Adogen® CDMC), and di-(oleoyloxyethyl)-N,N-methylhydroxyethylammonium methyl sulfate sold under the trade names Rewoquat® WE 15 and Varisoft® WE 16, both available from Degussa. Other antistatic agents include glycerol monostearate (Atmer® 129 from Uniqema), Ethofat® 245/25 (ethoxylated tall oil from Akzo Nobel), DC-5200® (lauryl PEG/PPG 18/18 methicone from Dow Corning), Ethomeen® 18/12 (bis[2-hydroxyethyl]octadecylamine from Akzo Nobel), Ethomeen® HT/12 (hydrogenated tallow amine 2 EO from Akzo Nobel), and Wacker L656 aminofunctional silicone (from Wacker Chemical Corporation). These are generally less effective SCAs when added to the wash cycle that contains an anionic detergent compared to the distearyl amine+cumene sulfonic acid ion pair and bis(distearyl)ammonium sulfate prills. However, if the fabric enhancer composition is being formulated for a powder/liquid dual compartment unit dose pouch using PVOH film, then these and other effective SCAs can be used in powder or granular form in the powder side of the unit dose pouch. Effective SCAs are given in U.S. Patent Application Publication No. 2005/0020476 A1, ¶¶15-74.

It has been discovered that for the best longer term stability of the ion pair antistatic agents, especially the distearyl amine/cumene sulfonic acid and distearyl amine/sulfuric acid prills, the level of anionic surfactant in an aqueous based composition (water level at least about 50%) should be at least about 4%, preferably at least about 5%. While not wishing to be bound by theory, it appears that the higher levels of anionic surfactant can form a coating around the SCA particles and provide protection against an unfavorable interaction with water such as hydrolysis. This interaction with water can decrease the static control performance when the fabric enhancer compositions are stored at elevated temperatures for longer periods of time, for example, at 38° C.

It has also been discovered that for best stability at higher storage temperatures (e.g., at 38° C.) of distearyl amine/cumene sulfonic acid and distearyl amine/sulfuric acid prills, the pH of the fabric enhancer composition should be less than about 7, preferably from about 3 to about 7, more preferably from about 4 to about 6.

It has also been surprisingly found that perfumes may negatively interact with the distearyl amine/cumene sulfonic acid and distearyl amine/sulfuric acid prill, with longer storage times and higher temperatures in fabric enhancer compositions. While not wishing to be bound by theory, it is believed that perfume components (perfume raw materials) that are hydrophobic solubilize and/or destroy the ion pair prill leading to eventual breakup of the prill into smaller pieces and eventually chemical reversion of the acid/base reaction that formed the ion pair. This perfume interaction with the ion pair can be solved in several ways. If the fabric enhancer composition is to be used in combination with a detergent product, for example, in a dual pour, dual compartment plastic bottle (an article where the fabric enhancer composition and the detergent composition are dispensed at the same time but are physically separated in one container), then the perfume is added to the liquid detergent; and the SCA, especially the distearyl amine/cumene sulfonic acid and distearyl amine/sulfuric acid prills, is added to the fabric enhancer composition. Another solution is to formulate the SCA into the detergent and the perfume into the fabric enhancer composition. Thus, the perfume and SCA are physically separated in storage in the container and no interactions can occur. This same method can be used for unit dose packaging for the fabric enhancer composition with either water-soluble or non-water soluble film or even dual compartment plastic containers or trays. For the water soluble unit dose case with polyvinyl alcohol film (PVOH), a dual compartment pouch is created by vacuum forming and sealing the films. The SCA and the perfume are physically separated since the SCA is in the powder side of the pouch and the perfume is in the fabric enhancer composition in the liquid side of the pouch.

Another way to solve the stability issue is to form an article with two compartments such as a unit dose PVOH pouch. In this case, two liquid fills are used. On one side, the liquid or gel fabric enhancer composition containing the SCA, esp. the distearyl amine/cumene sulfonic acid and distearyl amine/sulfuric acid prills is added, but does not contain the perfume in this case. The perfume is added to the other compartment of the dual compartment pouch either by itself or as a mixture in a dispersing solvent. An example of a dispersing solvent is dipropylene glycol or other glycols or solvatropes or fatty alcohol ethoxylates or mixtures thereof. The concentration of perfume with dispersing solvent can be from about 5% to about 95% by weight of perfume, preferably from about 15% to about 75% perfume, and more preferably from about 20% to about 50% perfume.

Even another way to solve the stability issue of perfume and SCA, especially with the distearyl amine/cumene sulfonic acid and distearyl amine/sulfuric acid prills, is to use perfume microcapsules instead of perfume oil. Perfume microcapsules are available from several suppliers such as Aveka (for example, a urea formaldehyde shell with a perfume core). An advantage for this approach is that perfume can effective be added to the fabric enhancer compositions containing the distearyl amine/cumene sulfonic acid and distearyl amine/sulfuric acid prills, and thus a simple, single compartment unit dose article can be used. Also, a more stable liquid fabric enhancer composition containing the SCA and with the perfume in microcapsules can be used in a standard plastic bottle or other container. In one embodiment, the perfume microcapsule is friable. In another embodiment, the perfume microcapsule is moisture-activated. In another embodiment, the perfume microcapsule is heat-activated (for example, by the machine dryer).

### H. Fabric Softening Agents

### 1. Diester Quaternary Ammonium (DEQA) Compounds

In one embodiment, the fabric care active is a fabric softening active comprising a DEQA compound. The DEQA compounds encompass a description of diamido fabric softener actives as well as fabric softener actives with mixed amido and ester linkages.

A first type of DEQA (“DEQA (1)”) suitable as a fabric softening active in the present compositions includes compounds of the formula:

{R₄₋ₘ—N⁺—[(CH₂)ₙ—Y—R¹]ₘ}X⁻

wherein each R substituent is either hydrogen, a short chain C₁-C₆, preferably C₁-C₃ alkyl or hydroxyalkyl group, e.g., methyl (most preferred), ethyl, propyl, hydroxyethyl, and the like, poly (C₂₋₃ alkoxy), preferably polyethoxy, group, benzyl, or mixtures thereof; each m is 2 or 3; each n is from 1 to about 4, preferably 2; each Y is —O—(O)C—, —C(O)—O—, —NR—C(O)—, or —C(O)—NR— and it is acceptable for each Y to be the same or different; the sum of carbons in each R¹, plus one when Y is —O—(O)C— or —NR—C(O)—, is C₁₂-C₂₂, preferably C₁₄-C₂₀, with each R¹ being a hydrocarbyl, or substituted hydrocarbyl group; it is acceptable for R¹ to be unsaturated or saturated and branched or linear and preferably it is linear; it is acceptable for each R¹ to be the same or different and preferably these are the same; and X⁻ can be any softener-compatible anion, preferably, chloride, bromide, methylsulfate, ethylsulfate, sulfate, phosphate, and nitrate, more preferably chloride or methyl sulfate. Preferred DEQA compounds are typically made by reacting alkanolamines such as MDEA (methyldiethanolamine) and TEA (triethanolamine) with fatty acids. Some materials that typically result from such reactions include N,N-di(acyl-oxyethyl)-N,N-dimethylammonium chloride or N,N-di(acyl-oxyethyl)-N,N-methylhydroxyethylammonium methyl sulfate wherein the acyl group is derived from animal fats, unsaturated, and polyunsaturated, fatty acids, e.g., oleic acid, and/or partially hydrogenated fatty acids, derived from vegetable oils and/or partially hydrogenated vegetable oils, such as, canola oil, safflower oil, peanut oil, sunflower oil, corn oil, soybean oil, tall oil, rice bran oil, etc. Non-limiting examples of suitable fatty acids are listed in U.S. Pat. No. 5,759,990 at column 4, lines 45-66. Those skilled in the art will recognize that active softener materials made from such process can comprise a combination of mono-, di-, and tri-esters depending on the process and the starting materials. Materials from this group preferred for the present invention include those comprising a high level of diester content; more than 40%, preferably more than 55%, preferably more than 60%, still more preferably than 70%, and yet still more preferably at least about 80% of the total softener active weight (as used herein, the total softener active weight includes the mass encompassing all reaction products that comprise one or more R¹ groups, the percent softener active as used herein to quantify the individual percentages of mono-, di-, and tri-tail reaction products refers to the ratio of an individual portion (mass) of the total softener active wherein the constituents contain a common number of R¹ groups divided by the total softener active weight and multiplied by 100 to give a percentage of the total.) In one embodiment, the diester content comprises from about 55% to about 95% of the total percent of softener active weight. Materials from this group preferred for the present invention also include those comprising a low level of monoester content; preferably less than about 50%, preferably less than about 30%, more preferably less than about 25%, and yet more preferably less than about 20% monoester of the total percent of softener active weight. In another embodiment, the monoester content comprises more than about 1%, preferably more than about 5%, more preferably than about 10% of the total percent of softener active weight. Non-limiting examples of preferred diester quats for the present invention include N,N-di(tallowoyloxyethyl)-N,N-dimethylammonium chloride (available from Akzo under the trade name Armosoft® DEQ) and N,N-di(canola-oyloxyethyl)-N,N-dimethylammonium chloride (available from Degussa under the trade name Adogen® CDMC). Nonlimiting examples of available TEA ester quats suitable for the present invention include di-(hydrogenated tallowoyloxyethyl)-N,N-methylhydroxyethylammonium methyl sulfate and di-(oleoyloxyethyl)-N,N-methylhydroxyethylammonium methyl sulfate sold under the trade names Rewoquat® WE 15 and Varisoft® WE 16, both available from Degussa.

Additional preferred DEQA (1) actives include compounds comprising different Y structures such as the those having the structure below where one Y=C(O)—O— and the other Y=—NH—C(O)—:

R¹—C(O)O—R²—N⁺(R⁴)ₙ—R³—N(H)—C(O)—R¹X⁻

wherein n is 1 or 2; R¹ is a C₆-C₂₂, preferably a C₈-C₂₀, hydrocarbyl group or substituted hardrocarbyl groups that are branched or unbranched and saturated or unsaturated; R² and R³ are each C₁-C₅, preferably C₂-C₃, alkyl or alkylene groups; and R⁴ is H, or a C₁-C₃ alkyl or hydroxyalkyl group. A non-limiting example of such softener is N-tallowoyloxyethyl-N-tallowoylaminopropyl methyl amine. Additional non-limiting examples of such softeners are described in U.S. Pat. No. 5,580,481 and U.S. Pat. No. 5,476,597.

Other suitable fabric softening actives include reaction products of fatty acids with dialkylenetriamines in, e.g., a molecular ratio of about 2:1, said reaction products containing compounds of the formula:

R¹—C(O)—NH—R²—NH—R³—N(O)—R¹

wherein R¹, R² are defined as above, and each R³ is a C₁₋₆ alkylene group, preferably an ethylene group. Examples of these fabric softening actives are reaction products of tallow acid, canola acid, or oleic acids with diethylenetriamine in a molecular ratio of about 2:1, said reaction product mixture containing N,N″-ditallowoyldiethylenetriamine, N,N″-dicanola-oyldiethylenetriamine, or N,N″-dioleoyldiethylenetriamine, respectively, with the formula:

R¹—C(O)—NH—CH₂CH₂—NH—CH₂CH₂—NH—C(O)—R¹

wherein R² and R³ are divalent ethylene groups, R¹ is defined above and an acceptable examples of this structure when R¹ is the oleoyl group of a commercially available oleic acid derived from a vegetable or animal source, include Emersol® 223LL or Emersol® 7021, available from Henkel Corporation.

Another fabric softening active for use in the present compositions has the formula:

[R¹—C(O)—NR—R²—N(R)₂—R³—NR—C(O)—R¹]⁺X⁻

wherein R, R¹, R², R³ and X⁻ are defined as above. Examples of this fabric softening active are the di-fatty amidoamines based softener having the formula:

[R¹—C(O)—NH—CH₂CH₂—N(CH₃)(CH₂CH₂OH)—CH₂CH₂—NH—C(O)—R¹]⁺CH₃SO₄⁻

wherein R¹—C(O) is an oleoyl group, soft tallow group, or a hardened tallow group available commercially from Degussa under the trade names Varisoft® 222LT, Varisoft® 222, and Varisoft® 110, respectively.

A second type of DEQA (“DEQA (2)”) compound suitable as a fabric softening active in the present compositions has the general formula:

[R₃N⁺CH₂CH(YR¹)(CH₂YR¹)]X⁻

wherein each Y, R, R¹, and X⁻have the same meanings as before. Such compounds include those having the formula:

[CH₃]₃N⁽⁺⁾[CH₂CH(CH₂O(O)CR¹)O(O)CR¹]Cl⁽⁻⁾

wherein each R is a methyl or ethyl group and preferably each R¹ is in the range of C₁₅ to C₁₉. As used herein, when the diester is specified, it can include the monoester that is present. The amount of monoester that can be present is the same as in DEQA (1).

These types of agents and general methods of making them are disclosed in U.S. Pat. No. 4,137,180, Naik et al., issued Jan. 30, 1979. An example of a preferred DEQA (2) is the “propyl” ester quaternary ammonium fabric softener active having the formula 1,2-di(acyloxy)-3-trimethylammoniopropane chloride.

While it is acceptable to use fabric softening compounds with any transition temperature; preferably, for the present invention, the fabric softening compound has a transition temperature of equal to or less than about 50° C. It is acceptable for fabric softening compounds to be made with fatty acid precursors with a range of Iodine Values (herein referred to as IV) from about zero to about 140. One aspect of the invention provides for, but is not limited to, performance characteristics that include fabric softening composition and/or static performance based upon IV ranges. For example, in one embodiment the compositions of the present invention comprises an IV range of from at least about 40 to about 140; alternatively from at least about 35 to about 65, preferably from about 40 to about 60; alternatively from at least about 5 to about 60, preferably from about 15 to about 30, more preferably from about 15 to about 25.

Fabric softening compositions of the present invention that are clear preferably contain highly fluid fabric softening actives with transition temperatures less than about 35° C. These materials can be made with fatty acid precursors having high IV (greater than about 50) or comprising branching or other structural modifications leading to a low transition temperature. Additionally when unsaturated fabric softener actives are used for clear compositions the unsaturated moiety preferably has a cis:trans isomer ratio of at least 1:1, preferably about 2:1, more preferably about 3:1, and even more preferably 4:1 or higher. Some preferred actives for clear compositions are disclosed in U.S. Pat. No. 6,369,025; U.S. application Ser. No. 09/554,969, filed Nov. 24, 1998 by Frankenbach et al. (WO 99/27050); and U.S. Pat. No. 6,486,121.

While it is acceptable for the present invention for the composition to contain a number of softening actives, including other fabric softening actives disclosed herein below, the DEQA fabric softening actives, and specifically those fabric softener actives with two ester linkages, are preferred fabric softening actives for the present invention.

### 2. Other Fabric Softening Compounds

Instead of, or in addition to, the DEQA fabric softening actives described hereinbefore, the present compositions can also comprise a variety of other fabric softening actives. These other suitable fabric softening actives include:

(1) compounds having the formula:

[R^{4-m}—N⁽⁺⁾—R¹ₘ]A⁻

wherein each m is 2 or 3, each R¹ is a C₆-C₂₂, preferably C₁₄-C₂₀, but no more than one being less than about C₁₂ and then the other is at least about 16, hydrocarbyl, or substituted hydrocarbyl substituent, preferably C₁₀-C₂₀ alkyl or alkenyl (unsaturated alkyl, including polyunsaturated alkyl, also referred to sometimes as “alkylene”), most preferably C₁₂-C₁₈ alkyl or alkenyl, and branch or unbranched. While it is acceptable for the IV of the parent fatty acid containing the R¹ group to range from zero to about 140, it is preferred for the present invention to have an IV of at least about 40. When the fabric softener composition will be clear, it is preferred for fabric softener active to be highly fluid by incorporating branching in the hydrocarbyl group by incorporating high unsaturation e.g. the IV of a fatty acid containing this R¹ group is from about 70 to about 140, more preferably from about 80 to about 130; and most preferably from about 90 to about 115 (as used herein, the term “Iodine Value” means the Iodine Value of a “parent” fatty acid, or “corresponding” fatty acid, which is used to define a level of unsaturation for an R¹ group that is the same as the level of unsaturation that would be present in a fatty acid containing the same R¹ group) with, preferably, a cis/trans ratio as specified above for highly unsaturated compounds; each R is H or a short chain C₁-C₆, preferably C₁-C₃ alkyl or hydroxyalkyl group, e.g., methyl (most preferred), ethyl, propyl, hydroxyethyl, and the like, benzyl, or (R²O)₂₋₄H where each R² is a C₁₋₆ alkylene group; and A⁻ is a softener compatible anion, preferably, chloride, bromide, methylsulfate, ethylsulfate, sulfate, phosphate, or nitrate; more preferably chloride or methyl sulfate. Examples of these fabric softening actives include dialkydimethylammonium salts and dialkylenedimethylammonium salts such as ditallowedimethylammonium chloride, dicanoladimethylammonium chloride, and dicanoladimethylammonium methylsulfate. Examples of commercially available dialkylenedimethylammonium salts usable in the present invention are di-hydrogenated tallow dimethyl ammonium chloride, ditallowedimethyl ammonium chloride, and dioleyldimethylammonium chloride available from Degussa under the trade names Adogen® 442, Adogen® 470, and Adogen® 472, respectively.

(2) compounds having the formula:

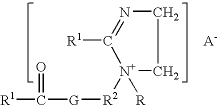

wherein each R, R¹, and A⁻ have the definitions given above; each R² is a C₁₋₆ alkylene group, preferably an ethylene group; and G is an oxygen atom or an —NR— group. Examples of this fabric softening active are 1-methyl-1-tallowylamidoethyl-2-oleylimidazolinium methylsulfate and 1-methyl-1-oleylamidoethyl-2-oleylimidazolinium methylsulfate wherein R¹ is an acyclic aliphatic C₁₅-C₁₇ hydrocarbon group, R² is an ethylene group, G is a NH group, R⁵ is a methyl group and A⁻ is a methyl sulfate anion, available commercially from Degussa under the trade names Varisoft® 475 and Varisoft® 3690, respectively.

(3) compounds having the formula:

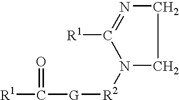

wherein R¹, R² and G are defined as above. An example of this fabric softening active is 1-oleylamidoethyl-2-oleylimidazoline wherein R¹ is an acyclic aliphatic C₁₅-C₁₇ hydrocarbon group, R² is an ethylene group, and G is a NH group.

(4) reaction products of substantially unsaturated and/or branched chain higher fatty acid with hydroxyalkylalkylenediamines in a molecular ratio of about 2:1, said reaction products containing compounds of the formula:

R¹—C(O)—NH—R²—N(R³OH)—C(O)—R¹

wherein R¹, R² and R³ are defined as above. Examples of this fabric softening active are reaction products of fatty acids such as tallow fatty acid, oleic fatty acid, or canola fatty acid with N-2-hydroxyethylethylenediamine in a molecular ratio of about 2:1, said reaction product mixture containing a compound of the formula:

R¹—C(O)—NH—CH₂CH₂—N(CH₂CH₂OH)—C(O)—R¹

wherein R¹—C(O) is oleoyl, tallowyl, or canola-oyl group of a commercially available fatty acid derived from a vegetable or animal source. Nonlimiting examples of such actives include Emersol® 223LL or Emersol® 7021, which are derived from oleic acid and available from Henkel Corporation.

(5) compounds having the formula:

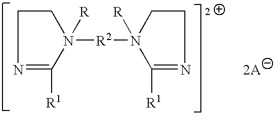

wherein R, R¹, R², and A⁻ are defined as above.

Other compounds suitable as fabric softening actives herein are acyclic quaternary ammonium salts having the formula:

[R¹—N(R⁵)₂—R⁶]⁺A⁻

wherein R⁵ and R⁶ are C₁-C₄ alkyl or hydroxyalkyl groups, and R¹ and A⁻ are defined as herein above. Examples of these fabric softening actives are the monoalkyltrimethylammonium salts and the monoalkenyltrimethylammonium salts such as monotallowyltrimethylammonium chloride, monostearyltrimethylammonium chloride, monooleyltrimethylammonium chloride, and monocanolatrimethylammonium chloride. Commercial examples include tallowtrimethylammonium chloride and soyatrimethylammonium chloride available from Degussa under the trade names Adogen® 471 and Adogene 415.

(6) substituted imidazolinium salts having the formula:

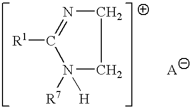

wherein R⁷ is hydrogen or a C₁-C₄ saturated alkyl or hydroxyalkyl group, and R¹ and A⁻ are defined as hereinabove;

(7) substituted imidazolinium salts having the formula:

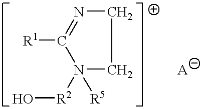

wherein R⁵ is a C₁-C₄ alkyl or hydroxyalkyl group, and R¹, R², and A⁻ are as defined above;

(8) alkylpyridinium salts having the formula:

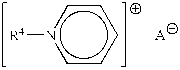

wherein R⁴ is an acyclic aliphatic C₈-C₂₂ hydrocarbon group and A⁻ is an anion. An example of this fabric softening active is 1-ethyl-1-(2-hydroxyethyl)-2-isoheptadecylimidazolinium ethylsulfate wherein R¹ is a C₁₋₇ hydrocarbon group, R² is an ethylene group, R⁵ is an ethyl group, and A⁻ is an ethylsulfate anion.

(9) alkanamide alkylene pyridinium salts having the formula:

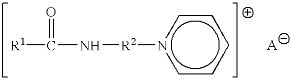

wherein R¹, R² and A⁻ are defined as herein above; and mixtures thereof.

Other suitable fabric softening actives for use in the present compositions include pentaerythritol compounds. Such compounds are disclosed in more detail in, e.g., U.S. Pat. No. 6,492,322 U.S. Pat. No. 6,194,374; U.S. Pat. No. 5,358,647; U.S. Pat. No. 5,332,513; U.S. Pat. No. 5,290,459; U.S. Pat. No. 5,750,990, U.S. Pat. No. 5,830,845 U.S. Pat. No. 5,460,736 and U.S. Pat. No. 5,126,060.

Polyquaternary ammonium compounds can also be useful as fabric softening actives in the present compositions and are described in more detail in the following patent documents: EP 803,498; GB 808,265; GB 1,161,552; DE 4,203,489; EP 221,855; EP 503,155; EP 507,003; EP 803,498; FR 2,523,606; JP 84-273918; JP 2-011,545; U.S. Pat. No. 3,079,436; U.S. Pat. No. 4,418,054; U.S. Pat. No. 4,721,512; U.S. Pat. No. 4,728,337; U.S. Pat. No. 4,906,413; U.S. Pat. No. 5,194,667; U.S. Pat. No. 5,235,082; U.S. Pat. No. 5,670,472; Weirong Miao, Wei Hou, Lie Chen, and Zongshi Li, Studies on Multifunctional Finishing Agents, Riyong Huaxue Gonye, No. 2, pp. 8-10, 1992; Yokagaku, Vol. 41, No. 4 (1992); and Disinfection, Sterilization, and Preservation, 4^{th} Edition, published 1991 by Lea & Febiger, Chapter 13, pp. 226-30. The products formed by quaternization of reaction products of fatty acid with N,N,N′,N′, tetraakis(hydroxyethyl)-1,6-diaminohexane are also suitable for use in the present invention.

Examples of ester and/or amide linked fabric softening actives useful in the present invention, especially for concentrated clear compositions, are disclosed in U.S. Pat. No. 5,759,990 and U.S. Pat. No. 5,747,443. Other fabric softening actives for clear liquid fabric softening compositions are described in U.S. Pat. No. 6,323,172.

Examples of suitable amine softeners that can be used in the present invention as fabric softening actives are disclosed in U.S. Pat. No. 6,630,441. Other fabric softening actives that can be used herein are disclosed, at least generically for the basic structures, in U.S. Pat. No. 3,861,870; U.S. Pat. No. 4,308,151; U.S. Pat. No. 3,886,075; U.S. Pat. No. 4,233,164; U.S. Pat. No. 4,401,578; U.S. Pat. No. 3,974,076; and U.S. Pat. No. 4,237,016. Examples of more biodegradable fabric softeners can be found in U.S. Pat. No. 3,408,361; U.S. Pat. No. 4,709,045; U.S. Pat. No. 4,233,451; U.S. Pat. No. 4,127,489; U.S. Pat. No. 3,689,424; U.S. Pat. No. 4,128,485; U.S. Pat. No. 4,161,604; U.S. Pat. No. 4,189,593; and U.S. Pat. No. 4,339,391.

The fabric softening active in the present compositions is preferably selected from the group consisting of ditallowoyloxyethyl dimethyl ammonium chloride, dihydrogenated-tallowoyloxyethyl dimethyl ammonium chloride, dicanola-oyloxyethyl dimethyl ammonium chloride, ditallow dimethyl ammonium chloride, tritallow methyl ammonium chloride, methyl bis(tallow amidoethyl)-2-hydroxyethyl ammonium methyl sulfate, methyl bis(hydrogenated tallow amidoethyl)-2-hydroxyethyl ammonium methyl sulfate, methyl bis(oleyl amidoethyl)-2-hydroxyethyl ammonium methyl sulfate, ditallowoyloxyethyl dimethyl ammonium methyl sulfate, dihydrogenated-tallowoyloxyethyl dimethyl ammonium chloride, dicanola-oyloxyethyl dimethyl ammonium chloride, N-tallowoyloxyethyl-N-tallowoylaminopropyl methyl amine, 1,2-bis(hardened tallowoyloxy)-3-trimethylammonium propane chloride, and mixtures thereof.

### I. Solvents

Solvents are useful for fluidizing the fabric softening compositions of the present invention, and may provide good dispersibility, and in some embodiments, provide a clear or translucent composition. Suitable solvents of the present invention can be water-soluble or water-insoluble. Non-limiting examples include ethanol, propanol, isopropanol, n-propanol, n-butanol, t-butanol, propylene glycol, 1,3-propanediol, ethylene glycol, diethylene glycol, dipropylene glycol, 1,2,3-propanetriol, propylene carbonate, phenylethyl alcohol, 2-methyl 1,3-propanediol, hexylene glycol, glycerol, sorbitol, polyethylene glycols, 1,2-hexanediol, 1,2-pentanediol, 1,2-butanediol, 1,4 butanediol, 1,4-cyclohexanedimethanol, pinacol, 1,5-hexanediol, 1,6-hexanediol, 2,4-dimethyl-2,4-pentanediol, 2,2,4-trimethyl-1,3-pentanediol (and ethoxylates), 2-ethyl-1,3-hexanediol, phenoxyethanol (and ethoxylates), glycol ethers such as butyl carbitol and dipropylene glycol n-butyl ether, ester solvents such as dimethyl esters of adipic, glutaric, and succinic acids, hydrocarbons such as decane and dodecane, or combinations thereof. In one embodiment, the composition is free or substantially free of one or more of the above-identified solvents.

Other examples of solvents include so called “principal solvents” preferably having a C log P of from about −2.0 to about 2.6, more preferably from about −1.7 to about 1.6, as defined hereinafter, typically at a level that is less than about 80%, preferably from about 10% to about 75%, more preferably from about 30% to about 70% by weight of the composition. The “calculated log P” (C log P) is determined by the fragment approach of Hansch and Leo (cf., A. Leo, in Comprehensive Medicinal Chemistry, Vol. 4, C. Hansch, P. G. Sammens, J. B. Taylor and C. A. Ramsden, Eds., p. 295, Pergamon Press, 1990. Principle solvents or principal solvent systems are described at U.S. Pat. Nos. 6,323,172; 6,369,025; and 5,747,443. The level of aqueous or aqueous plus solvent carrier may generally constitute the balance of the present compositions.

It will be recognized that solvents can be in solid form at room temperature and are not required to be liquids; for example, 1,4-cyclohexanedimethanol is a solid at 25° C. In addition, surface active materials can be solvents, preferably nonionic or anionic surfactants. Especially preferred are alcohol ethoxylates. Additionally, free fatty acids, fatty acid soaps, fatty triglycerides, and fatty amines, amides, alcohols can also be solvents. Especially preferred are materials that are liquid at room temperature comprised of shorter chain length, unsaturated, and/or branched fatty acid moieties.

### J. Thickeners and Structurants

Compositions of the present invention may contain a structurant or structuring agent. Structurants can also build viscosity to produce a preferred liquid gel product form. Suitable levels of this component are in the range from about 0% to 20%, preferably from 0.1% to 10%, and even more preferably from 0.1% to 3% by weight of the composition. The structurant serves to stabilize the silicone polymer in the inventive compositions and to prevent it from coagulating and/or creaming. This is especially important when the inventive compositions have fluid form, as in the case of liquid or the gel-form fabric enhancer compositions.

Structurants suitable for use herein can be selected from thickening stabilizers. These include gums and other similar polysaccharides, for example gellan gum, carrageenan gum, xanthan gum, Diutan gum (ex. CP Kelco) and other known types of thickeners and rheological additives such as Rheovis CDP (ex. Ciba Specialty Chemicals), Alcogum L-520 (ex. Alco Chemical), and Sepigel 305 (ex. SEPPIC).

One preferred structurant is a crystalline, hydroxyl-containing stabilizing agent, more preferably still, a trihydroxystearin, hydrogenated oil or a derivative thereof.

Without intending to be limited by theory, the crystalline, hydroxyl-containing stabilizing agent is a nonlimiting example of a “thread-like structuring system.” “Thread-like Structuring System” as used herein means a system comprising one or more agents that are capable of providing a chemical network that reduces the tendency of materials with which they are combined to coalesce and/or phase split. Examples of the one or more agents include crystalline, hydroxyl-containing stabilizing agents and/or hydrogenated jojoba. Surfactants are not included within the definition of the thread-like structuring system. Without wishing to be bound by theory, it is believed that the thread-like structuring system forms a fibrous or entangled threadlike network in-situ on cooling of the matrix. The thread-like structuring system has an average aspect ratio of from 1.5:1, preferably from at least 10:1, to 200:1.

The thread-like structuring system can be made to have a viscosity of 0.002 m²/s (2,000 centistokes at 20° C.) or less at an intermediate shear range (5 s⁻¹ to 50 s⁻¹) which allows for the pouring of the fabric enhancer composition out of a standard bottle, while the low shear viscosity of the product at 0.1 s⁻¹ can be at least 0.002 m²/s (2,000 centistokes at 20° C.) but more preferably greater than 0.02 m²/s (20,000 centistokes at 20° C.). A process for the preparation of a thread-like structuring system is disclosed in WO 02/18528.

In one embodiment, cationic acrylic based homopolymers are utilized as thickeners. One such thickener is sold under the name Rheovis CDE by Ciba Specialty Chemicals Corporation.

Other preferred stabilizers are uncharged, neutral polysaccharides, gums, celluloses, and polymers like polyvinyl alcohol, polyacrylamides, polyacrylates and co-polymers, and the like.

### K. Water

In one embodiment, the level of water in the fabric enhancer compositions is relatively high, for example at least about 50%, preferably at least about 60%, and more preferably at least about 70% water. These are generally for packaging in a single compartment plastic bottle or container, or in a dual compartment, dual pour plastic bottle or container combined with another fabric care composition, for example, a liquid detergent. In another embodiment the level of water in highly concentrated fabric enhancer compositions of the present invention is generally low, less than about 20% water, alternatively less than about 13%, alternatively less than about 10%, alternatively less than about 5%, alternatively even about zero, alternatively from about 1% to about 20%, by weight of the composition. Generally, some water is advantageous from about 8% to about 12% to prevent rigidity of a water soluble film, especially polyvinyl alcohol films used to encapsulate highly concentrated fabric enhancer compositions to form a unit dose. High water levels can cause the water soluble films used (for example, polyvinyl alcohol) to encapsulate said compositions of the present invention to leak or start to dissolve or disintegrate prematurely, either in the manufacturing process, during shipping/handling, or upon storage. However, it has been found that a low level of water can be desirable as medium for adding water-soluble dyes to the composition to give it an attractive color and to distinguish between compositions with different perfumes and/or added fabric care benefits. Oil soluble dyes can be used without the use of water medium but are not preferred since they can cause fabric staining to occur. In one embodiment a low level of water is needed to effectively hydrate a polymer such as cationic guar gum and/or a structuring agent in the context of a unit dose article with a water soluble film.

### L. Optional Ingredients

The fabric enhancer compositions of the present invention may comprise one or more optional ingredients. In yet another embodiment, the composition is free or substantially free of one or more optional ingredients.

### Fatty Acid

Fatty acid may be incorporated into fabric enhancer compositions as a softening active. In one embodiment, fatty acid may include those containing from about 12 to about 25, preferably from about 13 to about 22, more preferably from about 16 to about 20, total carbon atoms, with the fatty moiety containing from about 10 to about 22, preferably from about 12 to about 18, more preferably from about 14 (midcut) to about 18, carbon atoms. The fatty acids of the present invention may be derived from (1) an animal fat, and/or a partially hydrogenated animal fat, such as beef tallow, lard, etc.; (2) a vegetable oil, and/or a partially hydrogenated vegetable oil such as canola oil, safflower oil, peanut oil, sunflower oil, sesame seed oil, rapeseed oil, cottonseed oil, corn oil, soybean oil, tall oil, rice bran oil, palm oil, palm kernel oil, coconut oil, other tropical palm oils, linseed oil, tung oil, etc.; (3) processed and/or bodied oils, such as linseed oil or tung oil via thermal, pressure, alkali-isomerization and catalytic treatments; (4) a mixture thereof, to yield saturated (e.g. stearic acid), unsaturated (e.g. oleic acid), polyunsaturated (linoleic acid), branched (e.g. isostearic acid) or cyclic (e.g. saturated or unsaturated α-disubstituted cyclopentyl or cyclohexyl derivatives of polyunsaturated acids) fatty acids. Non-limiting examples of fatty acids (FA) are listed in U.S. Pat. No. 5,759,990 at col 4, lines 45-66.

Mixtures of fatty acids from different fat sources can be used, and in some embodiments preferred. Nonlimiting examples of FA's that can be blended, to form FA's of this invention are as follows:

| Fatty Acyl Group | FA¹ | FA² | FA³ |
|---|---|---|---|
| C₁₄ | 0 | 0 | 1 |
| C₁₆ | 3 | 11 | 25 |
| C₁₈ | 3 | 4 | 20 |
| C14:1 | 0 | 0 | 0 |
| C16:1 | 1 | 1 | 0 |
| C18:1 | 79 | 27 | 45 |
| C18:2 | 13 | 50 | 6 |
| C18:3 | 1 | 7 | 0 |
| Unknowns | 0 | 0 | 3 |
| Total | 100 | 100 | 100 |
| IV | 99 | 125-138 | 56 |
| cis/trans (C18:1) | 5-6 | Not Available | 7 |
| TPU | 14 | 57 | 6 |

FA¹ is a partially hydrogenated fatty acid prepared from canola oil,
FA² is a fatty acid prepared from soybean oil, and
FA³ is a slightly hydrogenated tallow fatty acid.

It is preferred that at least a majority of the fatty acid that is present in the fabric softening composition of the present invention is unsaturated, e.g., from about 40% to 100%, preferably from about 55% to about 99%, more preferably from about 60% to about 98%, by weight of the total weight of the fatty acid present in the composition, although fully saturated and partially saturated fatty acids can be used. As such, it is preferred that the total level of polyunsaturated fatty acids (TPU) of the total fatty acid of the inventive composition is preferably from about 0% to about 75% by weight of the total weight of the fatty acid present in the composition.

The cis/trans ratio for the unsaturated fatty acids may be important, with the cis/trans ratio (of the C18:1 material) being from at least about 1:1, preferably at least about 3:1, more preferably from about 4:1, and even more preferably from about 9:1 or higher.

The unsaturated fatty acids preferably have at least about 3%, e.g., from about 3% to about 30% by weight, of total weight of polyunsaturates.

Typically, one would not want polyunsaturated groups in actives since these groups tend to be much more unstable than even monounsaturated groups. The presence of these highly unsaturated materials makes it desirable, and for the preferred higher levels of polyunsaturation, highly desirable, that the fatty acids of the present invention herein contain antibacterial agents, antioxidants, chelants, and/or reducing materials to protect from degradation. While polyunsaturation involving two double bonds (e.g., linoleic acid) is favored, polyunsaturation of three double bonds (linolenic acid) is not. It is preferred that the C18:3 level in the fatty acid be less than about 3%, more preferably less than about 1%, and even more preferably less than about 0.1%, by weight of the total weight of the fatty acid present in the composition of the present invention. In one embodiment, the fatty acid present in the composition is essentially free, preferably free of a C18:3 level.

Branched fatty acids such as isostearic acid are preferred since they may be more stable with respect to oxidation and the resulting degradation of color and odor quality.

The Iodine Value or “IV” measures the degree of unsaturation in the fatty acid. In one embodiment of the invention, the fatty acid has an IV preferably from about 40 to about 140, more preferably from about 50 to about 120 and even more preferably from about 85 to about 105.

### Clays

In one embodiment of the invention, the fabric care composition may comprise a clay as a fabric care active. In one embodiment clay can be a softener or co-softeners with another softening active, for example, silicone. Preferred clays include those materials classified geologically smectites and are described in U.S. Pat. Appl. Publ. 20030216274 A1, to Valerio Del Duca, et al., published Nov. 20, 2003, paragraphs 107-120.

Other suitable clays are described U.S. Pat. Nos. 3,862,058; 3,948,790; 3,954,632; 4,062,647; and U.S. Patent Application Publication No. 20050020476A1 to Wahl, et. al., page 5 and paragraph 0078 through page 6 and paragraph 0087.

### Perfume

The fabric enhancer compositions of the present invention can optionally further comprise perfume, typically at a level of from about 0.1% to about 10%, preferably from about 1% to about 6%, and more preferably from about 1% to about 4%, by weight of the composition. Preferably, the perfume comprises enduring perfume ingredients that have a boiling point of about 250° C. or higher and a C log P of about 3.0 or higher, more preferably at a level of at least about 25%, by weight of the perfume. Suitable perfumes, perfume ingredients, and perfume carriers are described in U.S. Pat. No. 5,500,138; and US 20020035053 A1

In one embodiment, the perfume comprises a perfume microcapsule. Suitable perfume microcapsules and perfume nanocapsules include: US 2003215417 A1; US 2003216488 A1; US 2003158344 A1; US 2003165692 A1; US 2004071742 A1; US 2004071746 A1; US 2004072719 A1; US 2004072720 A1; EP 1393706 A1; US 2003203829 A1; US 2003195133 A1; US 2004087477 A1; US 20040106536 A1; U.S. Pat. No. 6,645,479; U.S. Pat. No. 6,200,949; U.S. Pat. No. 4,882,220; U.S. Pat. No. 4,917,920; U.S. Pat. No. 4,514,461; U.S. RE 32,713; U.S. Pat. No. 4,234,627. For purposes of the present invention, the term “perfume microcapsules” describes both perfume microcapsules and perfume nanocapsules.

In yet another embodiment, the fabric enhancer composition of the present invention comprises odor control agents. Such agents include those described in U.S. Pat. No. 5,942,217: Uncomplexed cyclodextrin compositions for odor control”, granted Aug. 24, 1999. Other agents suitable odor control agents include those described in the following: U.S. Pat. No. 5,968,404, U.S. Pat. No. 5,955,093; U.S. Pat. No. 6,106,738; U.S. Pat. No. 5,942,217; and U.S. Pat. No. 6,033,679.

In one embodiment, the fabric care benefit is dry fabric odor or fragrance to fabric, and the fabric care benefit agent is a perfume. The perfume can be delivered to the wash via a unit dose, such composition being contained in a water soluble film such as polyvinyl alcohol. Typically, the perfume is preferably mixed with a dispersing solvent, a surfactant or mixture thereof, but can be used alone. An example of a dispersing solvent is dipropylene glycol or other glycols or solvatropes or fatty alcohol ethoxylates or mixtures thereof. The surfactant can be any surfactant or emulsifying agent previously mentioned used at a non-detersive level if administered in a 64-65 liter basin of an automatic washing machine of water. The concentration of perfume in the dispersing solvent can be from about 5% to about 95% perfume, preferably from about 15% to about 75% perfume, and more preferably from about 20% to about 50% perfume. In forming a unit dose article, for example with PVOH film, the dose of the perfume containing composition is from about 0.1 ml to about 30 ml, alternatively from about 0.5 ml to about 15 ml, alternatively from about 1 ml to about 5 ml. These can be in the form of pouches, envelopes, sachets, or round beads.

In another embodiment, the fabric care composition of the present invention is free or essentially free of other water insoluble fabric care benefit agents such as silicones or other water insoluble softening agents.

The fabric enhancer compositions can optionally further comprise a dye to impart color to the composition. Suitable dyes for the present fabric enhancer compositions are FD&C Blue #1 and Liquitint colorants (ex. Milliken Chemical Company).

The fabric enhancer compositions of the present composition can optionally further comprise other ingredients selected from the group consisting of bodying agents, drape and form control agents, smoothness agents, wrinkle control agents, sanitization agents, disinfecting agents, germ control agents, mold control agents, mildew control agents, antiviral agents, anti-microbials, drying agents, stain resistance and repelling agents, soil release agents, malodor control agents, fabric refreshing agents, chlorine bleach odor control agents, dye fixatives, dye transfer inhibitors, color maintenance agents, optical brighteners, color restoration/rejuvenation agents, anti-fading agents, whiteness enhancers, anti-abrasion agents, wear resistance agents, fabric integrity agents, anti-wear agents, defoamers and anti-foaming agents, rinse aids, UV protection agents for fabrics and skin, sun fade inhibitors, insect repellents, anti-allergenic agents, enzymes, water proofing agents, fabric comfort agents, water conditioning agents, shrinkage resistance agents, stretch resistance agents, and mixtures thereof. A useful enzyme for improving the appearance and softness of cotton containing fabrics is a cellulase.

The fabric enhancer compositions of the present invention are preferably free of effective levels of detersive surfactants. Detersive surfactants, distinguished from the surfactants that are acting as emulsifiers or dispersing agents, are surfactants that are present in a composition in an amount effective to provide noticeable soil removal from fabrics. Typical detersive surfactants include anionic surfactants, such as alkyl sulfates and alkyl sulfonates, and nonionic surfactants, such as C₈-C₁₈ alcohols condensed with from 1 to 9 moles of C₁-C₄ alkylene oxide per mole of C₈-C₁₈ alcohol. Typical levels of surfactant in typical quality detergents are from about 12% to about 22%, and are used at a dosage in the range from about 90 g to about 120 g.

Preferred forms of the fabric enhancer composition of the present invention are liquids and gels. The fabric enhancer composition can also be in the form of a paste, semi-solid, suspension, powder, or any mixture thereof. A dual compartment article, for example a dual compartment unit dose made form PVOH film, can be comprised of the same or 2 different forms, for example a liquid/powder pouch, a liquid/liquid pouch, and a gel/powder pouch.

The fabric enhancer compositions of the present invention, when added to a rinse solution of a laundering process, provide a concentration of at least about 10 ppm, preferably at least about 20 ppm, preferably at least about 50 ppm, and more preferably from about 50 ppm to about 200 ppm, of fabric softening active (for example, silicone) and any optional co-softening compound in the wash solution. Applicants have found that these levels are preferred to provide an effective level to provide a noticeable softness benefit. Higher softener active concentrations could provide more softness, but could also possibly create staining or spotting and unnecessary cost. However, if for example, wrinkle control of fabrics is the primary fabric care benefit, higher softening active levels (for example, silicone) could be used.

The fabric enhancer compositions of the present invention can be added directly, as-is, to the wash cycle, preferably as a unit dose composition. It is preferred that the film of the coating material be water-soluble, preferably made of polyvinyl alcohol or a derivative of polyvinyl alcohol. Films comprised of hydroxypropyl methylcellulose and polyethylene oxide may also be used, as well as mixtures thereof, and mixtures with PVOH. Water-insoluble films can also be used, such as polyethylene and the like, for pouching.

When a fabric enhancer composition contained in a coating material comprising a film is desired, these materials may be obtained in a film or sheet form that may be cut to a desired shape or size. Specifically, it is preferred that films of polyvinyl alcohol, hydroxypropyl methyl cellulose, methyl cellulose, non-woven polyvinyl alcohols, PVP and gelatins or mixtures be used to encapsulate the fabric enhancer compositions. Polyvinyl alcohol films are commercially available from a number of sources including MonoSol LLC of Gary, Ind., Nippon Synthetic Chemical Industry Co. Ltd. Of Osaka Japan, and Ranier Specialty Chemicals of Yakima, Washington. These films may be used in varying thicknesses ranging from about 20 to about 80 microns, preferably from about 25 to about 76 microns. For purposes of the present invention, it is preferred to use a film having a thickness of about 25 to about 76 micrometers for rapid dissolution in a cold water wash. Where larger volumes of composition are to be contained in encapsulate, volumes exceeding about 25 ml, a thicker film may be desired to provide additional strength and integrity to the encapsulate. Further, it is preferred that the water-soluble films be printable and colored as desired.

Encapsulate articles such as pouches, pillows, sachets, beads, or envelopes are easily manufactured by heat-sealing multiple sheets together at their edges, leaving an opening for inserting the fabric enhancer composition. This opening can then be heat-sealed after the fabric enhancer composition has been introduced. Pouches can also be made by vacuum forming and sealing. The size of the film segments used will depend on the volume of composition to be encapsulated. Heat sealing is described as one preferred method for forming and sealing encapsulated articles of the present invention, but it should be recognized that the use of adhesives, mechanical bonding, and partially solvating the films with water, solvents, and mixtures thereof, are alternative preferred methods for forming encapsulated articles. One suitable method for producing an article containing a composition of the present invention is thermoforming, preferably a water soluble film. The thermoforming process consists of first placing a sheet of film over a forming mold having at least one forming cavity and heating the film so that it forms into the recess of the cavity, placing a composition of the present invention into the formed cavity, and sealing a second sheet of film across the recess to form the closed article. Articles of multiple cavities may also be thermoformed in the same manner with heat applied to additional layers of film to make an additional recess for a second compartment to contain a composition of the present invention. Similar processes describing related unit dose articles can be found in U.S. Pat. No. 6,281,183 B1, EP1126070, WO0183668, WO0183669, WO0185898, WO0183661, WO0183657, WO0183667, WO0185892, WO00208380, WO0212432, WO0220361, WO0240351, WO00183658, WO0240370, WO0160966, WO02060758, WO02060980, WO02074893, WO02057402, WO03008513, WO03008486, WO03031266, WO03045812, WO03045813, WO02060757, EP1354939, EP1375351, EP1396440, EP1431383, EP1431384, EP1340692, WO04085586. A unit dose article can also consist of the enclosed composition of the present invention shaped into a spherical bead as is described in WO 97/35537.

During the manufacture of a unit dose with a film, for example PVOH, it is useful to leave an air bubble in the pouch of a liquid composition. The air bubble is formed by slightly under filling the liquid composition into the pouch as it is being formed, for example, by vacuum. This helps prevent the liquid composition from contacting the sealing area of the film, for example when a second film is placed over the first film that is holding the liquid composition. The air bubble is from about 0.1 ml to about 10 ml in volume, alternatively from about 0.5 ml to about 5 ml. The air bubble also is a good aesthetic visual signal for the consumer that the filled pouch actually contains a liquid composition. As a visual signal, the bubble should be from about 1 mm to about 20 mm in diameter, alternatively from about 3 mm to about 10 mm.

### Plasticizers

For compositions intended to be enclosed or encapsulated by a film, especially a highly water-soluble film like polyvinyl alcohol, it is desirable to incorporate the same or similar plasticizers found in the film into the fabric softener composition. This helps reduce or prevent migration of the film plasticizers into the softener composition. Loss of plasticizers from the film can cause the article to become brittle and/or lose mechanical strength over time. Typical plasticizers to include in the highly concentrated fabric softener composition are glycerin, sorbitol, 1,2 propanediol, polyethylene glycols (PEGs), and other diols and glycols and mixtures. Compositions should contain from at least about 0.1%, preferably at least about 1%, and more preferably at least about 5% to about 70% plasticizer or mixture of plasticizers.

In some embodiments, for example one contained in a water soluble film, it is necessary to choose solvents that do not compromise the physical integrity of the water soluble film. Some solvents act as plasticizers that will soften the film over time, others cause the film to become brittle over time by leaching out plasticizers from the water soluble film. The ratio of the plasticizing to non-plasticizing solvents in the formulation to be contained in the water soluble film must be balanced to uphold the physical integrity of the water soluble film over time. For example, one preferred mixture of solvents is polyethylene glycol (PEG) and glycerin in a ratio between about 4:3 to about 2:3 respectively, more preferably wherein the PEG is PEG-400. Another example is a mixture of three solvents, preferably polyethylene glycol (PEG), glycerin, and propylene glycol wherein the ratio of the PEG and glycerin is between about 4:3 to about 2:3, and the balance of the solvent composition of the formulation is made up of propylene glycol.

The present invention can also include other compatible ingredients, including those disclosed U.S. Pat. Nos. 5,686,376; 5,536,421.

### Hueing Dyes and Brighteners.

In one embodiment, the fabric enhancer composition comprising a hueing dye. A preferred hueing dye is one that exhibits a hueing efficiency of at least about 20 and a wash removal value in the range of from about 50% to about 98%. Suitable hueing dyes are described in the U.S. publication for pending U.S. application Ser. No. 11/244,774 (P&G Case 9795); and U.S. Pat. Publ. Nos.: 2005/0288207 A1; 2005/0287654 A1. Specific hueing dyes may include: Acid Violet 43 (Anthraquinone); Acid Violet 49 (Triphenylmethane); Acid Blue 92 (Monoazo); Liquitint Violet DD; Liquitint Violet CT; and Liquitint Violet LS (from Milliken Chemical).

In another embodiment, the fabric enhancer composition of the present invention comprises a brightener. Suitable brighteners, also called optical brighteners or fluorescent whitening agents (FWAs), are more fully described in the following: (1) Ullman's Encyclopedia of Industrial Chemistry, Fifth Edition, Vol. A18, Pages 153 to 176; (2) Kirk-Othmer Encyclopedia of Chemical Technology, Volume 11, Fourth Edition; and (3) Fluorescent Whitening Agents, Guest Editors R. Anliker and G. Muller, Georg Thieme Publishers Stuttgart (1975).

### Chelating Agents

The compositions and processes herein can optionally employ one or more copper and/or nickel chelating agents (“chelators”). Such water-soluble chelating agents can be selected from the group consisting of amino carboxylates, amino phosphonates, polyfunctionally-substituted aromatic chelating agents and mixtures thereof, all as hereinafter defined. The whiteness and/or brightness of fabrics are substantially improved or restored by such chelating agents and the stability of the materials in the compositions are improved. The chelating agents disclosed in said U.S. Pat. No. 5,759,990 at column 26, line 29 through column 27, line 38 are suitable.

A wide variety of chelators can be used herein. Indeed, simple polycarboxylates such as citrate, oxydisuccinate, and the like, can also be used, although such chelators are not as effective as the amino carboxylates and phosphonates, on a weight basis.

Accordingly, usage levels may be adjusted to take into account differing degrees of chelating effectiveness. The chelators herein will preferably have a stability constant (of the fully ionized chelator) for copper ions of at least about 5, preferably at least about 7, even more preferably from about 15 to 25. Typically, the chelators will comprise from about 0.1% to about 10%, more preferably from about 0.75% to about 5%, by weight of the compositions herein, in addition to those that are stabilizers. Preferred chelators include EDTA, DTPA (diethylenetriaminepentaacetic acid), DETMP, DETPA, NTA, EDDS, TPED (tetrahydroxypropyl ethylenediamine), and mixtures thereof.

### Dye Transfer Inhibition Agents

The compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in the compositions herein, the dye transfer inhibiting agents are present at levels from about 0.0001%, more preferably about 0.01%, most preferably about 0.05% by weight of the cleaning compositions to about 10%, more preferably about 2%, most preferably about 1% by weight of the compositions.

### Enzymes

Compositions of the present invention can comprise one or more of the following enzymes: Proteases like subtilisins from Bacillus [e.g. subtilis, lentus, licheniformis, amyloliquefaciens (BPN, BPN′), alcalophilus,] e.g. Esperase®, Alcalase®, Everlase® and Savinase® (Novozymes), BLAP and variants [Henkel]. Further proteases are described in EP130756, WO91/06637, WO95/10591 and WO99/20726. Amylases (a and/or P) are described in WO 94/02597 and WO 96/23873. Commercial examples are Purafect Ox Am® [Genencor] and Termamyl®, Natalase®, Ban®, Fungamyl® and Duramyl® [all ex Novozymes]. Cellulases include bacterial or fungal cellulases, e.g. produced by Humicola insolens, particularly DSM 1800, e.g. 50 Kda and ^{˜}43 kD [Carezyme®]. Also suitable cellulases are the EGIII cellulases from Trichoderma longibrachiatum. Suitable lipases include those produced by Pseudomonas and Chromobacter groups. Preferred are e.g. Lipolase^{R}, Lipolase Ultra^{R}, Lipoprime^{R} and Lipex^{R} from Novozymes. Also suitable are cutinases [EC 3.1.1.50] and esterases. Carbohydrases e.g. mannanase (U.S. Pat. No. 6,060,299), pectate lyase (WO99/27083) cyclomaltodextringlucanotransferase (WO96/33267) xyloglucanase (WO99/02663). Bleaching enzymes eventually with enhancers include e.g. peroxidases, laccases, oxygenases, (e.g. catechol 1,2 dioxygenase, lipoxygenase (WO 95/26393), (non-heme) haloperoxidases.

It is common practice to modify wild-type enzymes via protein/genetic engineering techniques in order to optimize their performance in the detergent compositions. Enzymes levels in detergents in general are from 0.0001% to 2%, preferably 0.001% to 0.2%, more preferably 0.005% to 0.1% pure enzyme (weight % of the composition).

### Enzymes Stabilizers

Enzymes can be stabilized using any known stabilizer system like calcium and/or magnesium compounds, boron compounds and substituted boric acids, aromatic borate esters, peptides and peptide derivatives, polyols, low molecular weight carboxylates, relatively hydrophobic organic compounds [e.g. certain esters, diakyl glycol ethers, alcohols or alcohol alkoxylates], alkyl ether carboxylate in addition to a calcium ion source, benzamidine hypochlorite, lower aliphatic alcohols and carboxylic acids, N,N-bis(carboxymethyl)serine salts; (meth)acrylic acid-(meth)acrylic acid ester copolymer and PEG; lignin compound, polyamide oligomer, glycolic acid or its salts; poly hexa methylene biguanide or N,N-bis-3-amino-propyl-dodecyl amine or salt; and mixtures thereof.

In liquid matrix, the degradation by the proteolytic enzyme of second enzymes can be avoided by protease reversible inhibitors [e.g. peptide or protein type, in particular the modified subtilisin inhibitor of family VI and the plasminostrepin; leupeptin, peptide trifluoromethyl ketones, peptide aldehydes.

### Defoamers & Anti-Foaming Agents

Compounds for reducing or suppressing the formation of suds in the wash or rinse bath solutions may also be unitized for use in the present invention. Suds suppression can be of particular importance in the so-called “high concentration cleaning process” as described in U.S. Pat. Nos. 4,489,455 and 4,489,574 and in front-loading European-style washing machines.

A wide variety of materials may be used as suds suppressers, and suds suppressers are well known to those skilled in the art. See, for example, Kirk Othmer Encyclopedia of Chemical Technology, Third Edition, Volume 7, pages 430-447 (John Wiley & Sons, Inc., 1979). One category of suds suppresser of particular interest encompasses monocarboxylic fatty acid and soluble salts therein, as described in U.S. Pat. No. 2,954,347, issued Sep. 27, 1960 to Wayne St. John. The monocarboxylic fatty acids and salts thereof used as suds suppressor typically have hydrocarbyl chains of 10 to about 24 carbon atoms, preferably 12 to 18 carbon atoms. Suitable salts include the alkali metal salts such as sodium, potassium, and lithium salts, and ammonium and alkanolammonium salts.

The compositions herein may also contain non-surfactant suds suppressers. These include, for example: high molecular weight hydrocarbons such as paraffin, fatty acid esters (e.g., fatty acid triglycerides), fatty acid esters of monovalent alcohols, aliphatic C₁₈-C₄₀ ketones (e.g., stearone), etc. Other suds inhibitors include N-alkylated amino triazines such as tri- to hexa-alkylmelamines or di- to tetra-alkyldiamine chlortriazines formed as products of cyanuric chloride with two or three moles of a primary or secondary amine containing 1 to 24 carbon atoms, propylene oxide, and monostearyl phosphates such as monostearyl alcohol phosphate ester and monostearyl di-alkali metal (e.g., K, Na, and Li) phosphates and phosphate esters. The hydrocarbons such as paraffin and haloparaffin can be utilized in liquid form. The liquid hydrocarbons will be liquid at room temperature and atmospheric pressure, and will have a pour point in the range of about −40° C. and about 50° C., and a minimum boiling point of not less than about 110° C. (atmospheric pressure). It is also known to utilize waxy hydrocarbons, preferably having a melting point below about 100° C. The hydrocarbons constitute a preferred category of suds suppresser for detergent compositions. Hydrocarbon suds suppressers are described, for example, in U.S. Pat. No. 4,265,779, issued May 5, 1981 to Gandolfo et al. The hydrocarbons, thus, include aliphatic, alicyclic, aromatic, and heterocyclic saturated or unsaturated hydrocarbons having from about 12 to about 70 carbon atoms. The term “paraffin,” as used in this suds suppresser discussion, is intended to include mixtures of true paraffins and cyclic hydrocarbons.

Another preferred category of non-surfactant suds suppressers comprises silicone suds suppressers. This category includes the use of polyorganosiloxane oils, such as polydimethyl-siloxane, dispersions or emulsions of polyorganosiloxane oils or resins, and combinations of polyorganosiloxane with silica particles wherein the polyorganosiloxane is chemisorbed or fused onto the silica. Silicone suds suppressers are well known in the art and are, for example, disclosed in U.S. Pat. No. 4,265,779, issued May 5, 1981 to Gandolfo et al and European Patent Application No. 89307851.9, published Feb. 7, 1990, by Starch, M. S. Other silicone suds suppressers are disclosed in U.S. Pat. No. 3,455,839 which relates to compositions and processes for defoaming aqueous solutions by incorporating therein small amounts of polydimethylsiloxane fluids.

Mixtures of suds suppressers may also be used to advantage. Mixtures of silicone and silanated silica are described in German Patent Application DOS 2,124,526. Silicone defoamers and suds controlling agents in granular detergent compositions are disclosed in U.S. Pat. No. 3,933,672, Bartolotta et al, and in U.S. Pat. No. 4,652,392, Baginski et al. Another preferred foam suppressant is a silicone/silicate mixture, e.g., Dow Corning's Antifoam AR.

An exemplary silicone based suds suppressor for use herein is a suds suppressing amount of a suds controlling agent consisting essentially of:
(i) polydimethylsiloxane fluid having a viscosity of from about 20 cs. to about 1,500 cs. at 25° C.;
(ii) from about 5 to about 50 parts per 100 parts by weight of (i) of siloxane resin composed of (CH₃)₃SiO_{1/2} units of SiO₂ units in a ratio of from (CH₃)₃ SiO_{1/2} units and to SiO₂ units of from about 0.6:1 to about 1.2:1; and
(iii) from about 1 to about 20 parts per 100 parts by weight of (i) of a solid silica gel.

In the preferred silicone suds suppressor used herein, the solvent for a continuous phase is made up of certain polyethylene glycols or polyethylene-polypropylene glycol copolymers or mixtures thereof (preferred), or polypropylene glycol. The primary silicone suds suppressor is branched/cross linked and preferably not linear.

To illustrate this point further, typical liquid compositions with controlled suds will optionally comprise from about 0.001 to about 1, preferably from about 0.01 to about 0.7, most preferably from about 0.05 to about 0.5, weight % of said silicone suds suppressor, which comprises (1) a nonaqueous emulsion of a primary antifoam agent which is a mixture of (a) a polyorganosiloxane, (b) a resinous siloxane or a silicone resin-producing silicone compound, (c) a finely divided filler material, and (d) a catalyst to promote the reaction of mixture components (a), (b) and (c), to form silanolates; (2) at least one nonionic silicone surfactant; and (3) polyethylene glycol or a copolymer of polyethylene-polypropylene glycol having a solubility in water at room temperature of more than about 2 weight %; and without polypropylene glycol. Similar amounts can be used in granular compositions, gels, etc, as described in U.S. Pat. Nos. 4,978,471, Starch, issued Dec. 18, 1990, and 4,983,316, Starch, issued Jan. 8, 1991, 5,288,431, Huber et al., issued Feb. 22, 1994, and 4,639,489 and 4,749,740, Aizawa et al at.

A silicone suds suppressor particularly useful in the compositions and articles of the present invention comprises polyethylene glycol and a copolymer of polyethylene glycol/polypropylene glycol, all having an average molecular weight of less than about 1,000, preferably between about 100 and 800. The polyethylene glycol and polyethylene/polypropylene glycol copolymers herein have a solubility in water at room temperature of more than about 2%, and preferably more than about 5% by weight. The preferred solvent herein is polyethylene glycol having an average molecular weight of less than about 1,000, more preferably between about 100 and 800, most preferably between 200 and 400, and a copolymer of polyethylene glycol/polypropylene glycol, preferably PPG 200/PEG 300. Preferred is a weight ratio of between about 1:1 and 1:10, most preferably between 1:3 and 1:6, of polyethylene glycol:copolymer of polyethylene-polypropylene glycol.

Other suds suppressers useful herein comprise the secondary alcohols (e.g., 2-alkyl alkanols) and mixtures of such alcohols with silicone oils, such as the silicones disclosed in U.S. Pat. Nos. 4,798,679, 4,075,118 and EP 150,872. The secondary alcohols include the C₆-C₁₆ alkyl alcohols having a C₁-C₁₆ chain. A preferred alcohol is 2-butyl octanol, which is available from Condea under the trademark ISOFOL 12. Mixtures of secondary alcohols are available under the trademark ISALCHEM 123 from Enichem. Mixed suds suppressers typically comprise mixtures of alcohol+silicone at a weight ratio of 1:5 to 5:1.

### Rinse Aids

The fabric care actives of the present invention may also comprise rinse aids which typically comprise mixtures or one or more of the following fabric care agents: anti-foaming compounds, pH buffering agents, crystal growth inhibitors including carboxylic compounds, and organic diphosphonic and monophosphonic acids, heavy metal ion sequestrants including chelants and chlorine scavengers, hydrophobic dispersants, polymeric stabilizing agents, soil release polymers, preservatives, and anti-microbials.

### Ultraviolet Protection Agents

The incorporation of sunscreens and antioxidants into a wash or rinse bath solution for various benefits is also known in the art. For example, U.S. Pat. No. 4,900,469, teaches antioxidants in detergent solutions for bleach stability. Antioxidants have likewise been used in softeners and detergents to prevent fabric yellowing and to control malodor. (See, JP 72/116,783, Kao.) JP 63/162,798, teaches the use of sunscreens to stabilize the color of fabric conditioning compositions. U.S. Pat. No. 5,134,223, Langer et al., issued Jul. 28, 1992, teaches copolymers with a UV-absorbing monomer and a hydrophilic monomer to provide both anti-fading and soil release benefits. More specifically, this reference teaches the combination of a polymer of UV-absorbing monomers to a soil release polymer consisting of a hydrophilic group (e.g. ethoxylate) and hydrophobic group (e.g. terephthalate blocks). U.S. Pat. No. 5,250,652, Langer et al., issued Oct. 5, 1993, teaches copolymers containing at least one UVA light-absorbing moiety and/or one UVB light-absorbing moiety, one low molecular weight (i.e., monomeric) hydrophilic moiety, and optionally one hydrophobic moiety for fabric care (detergents, fabric softeners, etc.) and skin care applications (cosmetics, shampoos, sunscreens, personal cleansing compositions, etc.). The use of low molecular weight hydrophilic moieties allows a loading of UVA and/or UVB moieties of up to about 95% and provides better dispersibility of the polymer in an aqueous media. The optional hydrophobic moiety provides control over the deposition of the copolymer on a desired surface.

### Packaging

One aspect of the invention provides for a laundry article comprising: (a) a container comprising at least two compartments; (b) wherein at least in one compartment comprises any one composition of the present invention. In another embodiment, at least one compartment comprises a detersive surfactant composition. The term “detersive surfactant composition” is used herein the broadest sense to include any composition suitable to clean fabric, preferably in a washing machine. In yet another embodiment, the compartment comprising a composition of the present invention is different than the compartment comprising the detersive surfactant composition.

Any container comprising at least two compartments may be suitable. Non-limiting examples of such a container are described in include: U.S. Pat. No. 4,765,514, U.S. Pat. Appl. Pub. Nos. 2002/0077265 A1; and 2002/0074347 A1.

If the laundry article is a unit dose wherein the composition or compositions are encapsulated with a water soluble film (for example PVOH film), then the size of the article is from about 0.5 g to about 90 g, alternatively from about 5 g to about 50 g, and preferable from about 10 g to about 40 g.

### EXAMPLES

The following are non-limiting examples of the present invention.

| | Examples | | | | |
|---|---|---|---|---|---|
| INGREDIENTS | I | II | III | IV | V |
| Fabric softening active^{a} | 18.985% | 16.185% | 14.239% | 12.716% | 12.716% |
| Cationic starch^{b} | 1.466% | — | 1.10% | 0.97% | 0.97% |
| Perfume | 1.77% | 1.77% | 1.50% | 1.3% | 1.3% |
| Calcium chloride (25%) | 0.598% | 0.598% | 0.598% | 0.407% | 0.407% |
| DTPA (37%)^{c} | 0.02% | 0.02% | 0.02% | 0.01% | 0.01% |
| Preservative (1.5%)^{d} | 0.033% | 0.033% | 0.033% | 0.022% | 0.022% |
| Antifoam^{e} | 0.15% | 0.15% | 0.15% | 0.10% | 0.10% |
| Liquitint Blue Dye^{f} | 0.02% | 0.02% | 0.02% | 0.01% | 0.01% |
| Ammonium chloride (20%) | 0.573% | 0.573% | 0.573% | 0.390% | 0.390% |
| Hydrochloric acid (25%) | 0.032% | 0.032% | 0.032% | 0.022% | 0.022% |
| Silicone^{g} | 1.00% | 2.00% | 1.00% | 1.00% | 1.00% |
| Deposition Aid^{h} | 0.50% | 0.50% | 0.50% | 0.50% | 0.50% |
| Chelatorⁱ | 0.50% | 0.50% | 0.50% | — | — |
| Thickener^{j} | — | 0.25% | 0.25% | 0.25% | — |
| Deionized water | Balance | Balance | Balance | Balance | Balance |

^{a}N,N-di(tallowoyloxyethyl)-N,N-dimethylammonium chloride at 86.5% active and contains ethanol solvent.
^{b}Cationic starch based on common maize starch or potato starch, containing 25% to 95% amylose and a degree of substitution of from 0.02 to 0.09, and having a viscosity measured as Water Fluidity having a value from 50 to 84. Example: CHA 501 from National Starch.
^{c}Diethylenetriaminepentaacetic acid.
^{d}KATHON ® CG available from Rohm and Haas Co.
^{e}Silicone antifoam agent available from Dow Corning Corp. under the trade name DC2310 at 10% active.
^{f}Available from Milliken Chemical Company
^{g}50% emulsion of 60,000 cSt PDMS available from Dow Corning.
^{h}Polyethyleneimine, having an average molecular weight of ~25,000, available from BASF.
ⁱTetrahydroxypropyl ethylenediamine. Sold as Quadrol polyol from BASF.
^{j}Cationic acrylic homopolymer thickener available from Ciba.

All documents cited in the Detailed Description of the Invention are, are, in relevant part, incorporated herein by reference; the citation of any document is not to be construed as an admission that it is prior art with respect to the present invention.

It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed:

1. A fabric conditioning composition comprising:
a. a cationic polymer
b. less than about 20% silicone
c. a deposition aid
wherein the composition is essentially free of a coacervate.

2. The fabric conditioning composition of claim 1, further comprising a quaternary ammonium compound.

3. The fabric conditioning composition of claim 2, wherein the deposition aid is a polyethyleneimine.

4. The fabric conditioning composition of claim 1 wherein the cationic polymer is selected from cationic guar gum, a cationic cellulose polymer, starch, or a combination thereof.

5. The fabric conditioning composition of claim 4, wherein the cationic polymer is a starch.

6. The fabric conditioning composition of claim 1, further comprising a thickener.

7. The fabric conditioning composition of claim 1, wherein the silicone is selected form the silicone is a polydialkylsilicone; a polydimethyl silicone; polydimethyl siloxane or a derivative thereof; an aminofunctional silicone; alkyloxylated silicone, ethoxylated silicone; propoxylated silicone; ethoxylated/propoxylated silicone; quaternary silicone; amodimethicone; or combinations thereof.

8. The fabric conditioning composition of claim 1, where the silicone is polydimethyl siloxane or a derivative thereof.

9. The fabric conditioning composition of claims 1 through 8, further comprising a chelating agent.

10. The fabric conditioning composition of claim 9, further comprising a dye transfer inhibition agent.

11. The fabric conditioning composition of claim 1, comprising less than about 10% silicone.

12. The fabric conditioning composition of claim 1, comprising less than about 4% silicone.

13. A fabric conditioning composition comprising:
a. less than about 20% silicone
b. a deposition aid
wherein the composition is essentially free of anionic surfactant.

12. The fabric conditioning composition of claim 13, further comprising a quaternary ammonium compound.

13. The fabric conditioning composition of claim 13, wherein the deposition aid is a polyethyleneimine.

14. The fabric conditioning composition of claim 13 wherein the cationic polymer is selected from cationic guar gum, a cationic cellulose polymer, starch, or a combination thereof.

15. The fabric conditioning composition of claim 14, wherein the cationic polymer is a starch.

16. The fabric conditioning composition of claim 13, further comprising a thickener.

17. The fabric conditioning composition of claim 13, wherein the silicone is selected form the silicone is a polydialkylsilicone; a polydimethyl silicone; polydimethyl siloxane or a derivative thereof; an aminofunctional silicone; alkyloxylated silicone, ethoxylated silicone; propoxylated silicone; ethoxylated/propoxylated silicone; quaternary silicone;
amodimethicone; or combinations thereof.

18. The fabric conditioning composition of claim 13, where the silicone is polydimethyl siloxane or a derivative thereof.

19. The fabric conditioning composition of claims 13 through 18, further comprising a chelating agent.

20. The fabric conditioning composition of claim 19, further comprising a dye transfer inhibition agent.

21. The fabric conditioning composition of claim 13, comprising less than about 10% silicone.

22. The fabric conditioning composition of claim 13, comprising less than about 4% silicone.

23. The fabric conditioning composition of claims 1 through 22, further comprising an enzyme.

24. The fabric conditioning composition of claim 23, wherein the enzyme is a cellulase.
